(19) United States
(12) Patent Application Publication
(10) Pub. No.: US 2015/0235352 A1
(43) Pub. Date: Aug. 20, 2015

(54) IMAGE PROCESSING APPARATUS, IMAGE PROCESSING METHOD, AND PROGRAM

(71) Applicant: Sony Corporation, Minato-ku (JP)

(72) Inventor: Akihiro OKUMURA, Kanagawa (JP)

(73) Assignee: Sony Corporation, Minato-ku (JP)

(21) Appl. No.: 14/600,200

(22) Filed: Jan. 20, 2015

(30) Foreign Application Priority Data
Feb. 17, 2014 (JP) 2014-027220

(51) Int. Cl. G06T 5/00; G06T 3/40; H04N 1/60

(52) U.S. Cl. CPC G06T 5/002; H04N 1/60; G06T 3/4007

(57) ABSTRACT

There is provided an image processing apparatus that includes a green interpolation unit that, when a shape of low signals, which have, as a signal of each pixel of an image, a color signal that has been allocated to that pixel, is a predetermined shape, creates green image signals for all pixels that correspond to the low signals using only the low signals of green pixels, which are pixels to which green has been allocated.

### CROSS REFERENCE TO RELATED APPLICATIONS

This application claims the benefit of Japanese Priority Patent Application JP 2014-027220 filed Feb. 17, 2014, the entire contents of which are incorporated herein by reference.

### BACKGROUND

The present disclosure relates to an image processing apparatus, an image processing method, and a program, and in particular, relates to an image processing apparatus, an image processing method, and a program that are configured to be able to reduce zipper noise in an image signal after a demosaicing process.

A process that uses a Directional Linear Minimum Mean Square-Error Estimation (DLMMSE) technique has been devised is a demosaicing process that achieves both high resolution and a reduction in false coloring (for example, refer to Lei Zhang, Xiaolin Wu, “Color Demosaicking Via Directional Linear Minimum Mean Square-Error Estimation”, IEEE TRANSACTIONS ON IMAGE PROCESSING, VOL. 14, NO. 12, DECEMBER 2005).

In demosaicing processes that use the DLMMSE technique, firstly, a green image signal of each pixel is created. More specifically, a green image signal, which has the smallest square error, is respectively created for each pixel of an H (horizontal) direction and a V (vertical) direction of an image using the average value of a color difference with peripheral pixels, and the green image signals are set as an H interpolation signal and a V interpolation signal. Next, the directionality of the H direction and the V direction of the interpolating green image signals is detected for each pixel, the H interpolation signal and the V interpolation signal are distributed proportionally on the basis of the directionality thereof, and the green image signals are created. Further, a blue image signal and a red image signal of each pixel are created using the green image signal of each pixel after interpolation and virtual color differences (B−G and R−G).

In demosaicing processes that use the DLMMSE technique, it is possible to realize high resolution and low false coloring in the image signal in a case in which the directionality of the H direction and the V direction is detected accurately. However, in a case in which an image has a pattern that is close to a Nyquist frequency, there are cases in which the directionality is detected erroneously. If the directionality is detected erroneously, green image signals that differ greatly from true values are created, and disjointed false coloring is generated in the image signal.

In addition, in a case in which only red (R) and blue (B) are locally present within an image, a phenomenon that is referred to as decolorization, in which the average value of a color difference is reduced by an original color difference, occurs. As a result of such an instance, the green image signals rise locally, and noise that is referred to as zipper noise, in which white points and blue points are generated in isolation, is generated.

Meanwhile, in demosaicing processes that result from a class classification adaptive process, the green image signal of each pixel is created on the basis of the low signals of a peripheral pixel of the pixel prior to the demosaicing process, which is a signal with a color that has been allocated to that pixel. Therefore, in this demosaicing process also, in a case in which only red and blue are locally present within an image, the green image signals rise locally, and zipper noise is generated.

### SUMMARY

In the above-mentioned manner, in a case in which only red and blue are locally present within an image, zipper noise is generated in an image signal after a demosaicing process, and therefore, image quality deteriorates.

It is desirable to reduce zipper noise in an image signal after a demosaicing process.

According to an embodiment of the present disclosure, there is provided an image processing apparatus that includes a green interpolation unit that, when a shape of low signals, which have, as a signal of each pixel of an image, a color signal that has been allocated to that pixel, is a predetermined shape, creates green image signals for all pixels that correspond to the low signals using only the low signals of green pixels, which are pixels to which green has been allocated.

According to other embodiments of the present disclosure, there are provided an image processing method and a program that correspond to the image processing apparatus according to the embodiment of the present disclosure.

In the embodiments of the present disclosure, when a shape of low signals, which have, as a signal of each pixel of an image, a color signal that has been allocated to that pixel, is a predetermined shape, green image signal are created for all pixels that correspond to the low signals using only the low signals of green pixels, which are pixels to which green has been allocated.

According to the embodiments of the present disclosure, it is possible to perform a demosaicing process. In addition, according to the embodiments of the present disclosure, it is possible to reduce zipper noise in an image signal after a demosaicing process.

Additionally, the effects that are disclosed herein are not necessarily limited, and may be any effect that is disclosed in the present specification.

### BRIEF DESCRIPTION OF THE DRAWINGS

FIG. 1 is a block diagram that shows a configuration example of a first embodiment of an image processing apparatus to which the present disclosure has been applied;

FIG. 2 is a view that shows wedge-shaped low signals;

FIGS. 3A and 3B are views that describe processes of a G interpolation unit in FIG. 1;

FIG. 4 is a block diagram that shows a configuration example of the G interpolation unit in FIG. 1;

FIG. 5 is a block diagram that shows a configuration example of a horizontal direction calculation unit in FIG. 4;

FIGS. 6A and 6B are views that describe processes of a horizontal direction calculation unit in FIG. 5;

FIG. 7 is a view that describes processes of the horizontal direction calculation unit in FIG. 5;

FIG. 8 is a flowchart that describes a demosaicing process of the image processing apparatus in FIG. 1;

FIG. 9 is a flowchart that describes a shape determination process in FIG. 8 in detail;

FIG. 10 is a view that shows an example of a shape determination pixel group;

FIG. 11 is a flowchart than describes a gray_mode computation process in FIG. 9 in detail;

FIG. 12 is a view that shows an example of a grey computation pixel group;

FIG. 13 is a view that shows pixels that correspond to low signals that are used in the creation of an interpolation signal g;

FIG. 14 is a view that shows pixels that correspond to low signals that are used in the creation of an interpolation signal r;

FIG. 15 is a view that shows pixels that correspond to low signals that are used in the creation of an interpolation signal b;

FIG. 16 is a flowchart that describes a G creation process in FIG. 8 in detail;

FIG. 17 is a block diagram that shows a configuration example of a second embodiment of an image processing apparatus to which the present disclosure has been applied;

FIGS. 18A to 18D are views that show examples of tap structures of a G class tap, an R class tap, a B class tap, a G predicted tap, an R class tap and a G class tap;

FIG. 19 is a flowchart that describes a demosaicing process of the image processing apparatus in FIG. 17;

FIG. 20 is a flowchart that describes a G creation process in FIG. 19 in detail;

FIG. 21 is a block diagram that shows a configuration example of a learning device that learns a G predicted coefficient;

FIG. 22 is a flowchart that describes a G predicted coefficient learning process of the learning device in FIG. 21;

FIG. 23 is a view that shows another example of a pixel array that corresponds to low signals;

FIG. 24 is a flowchart that describes a shape determination process of a case in which a pixel array that corresponds to low signals is a double Bayer array; and

FIG. 25 is a block diagram that shows a configuration example of the hardware of a computer.

### DETAILED DESCRIPTION OF EMBODIMENTS

Hereinafter, the premise of the present disclosure and embodiments for implementing the present disclosure (hereinafter, referred to as embodiments) will be described. Additionally, the description will be given in the following order.

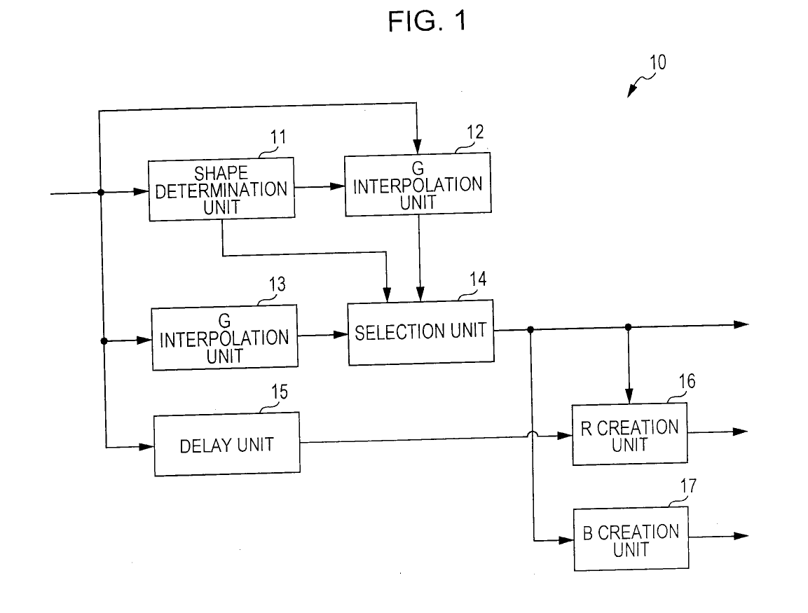

1. First Embodiment: Image Processing Apparatus (FIGS. 1 to 16)

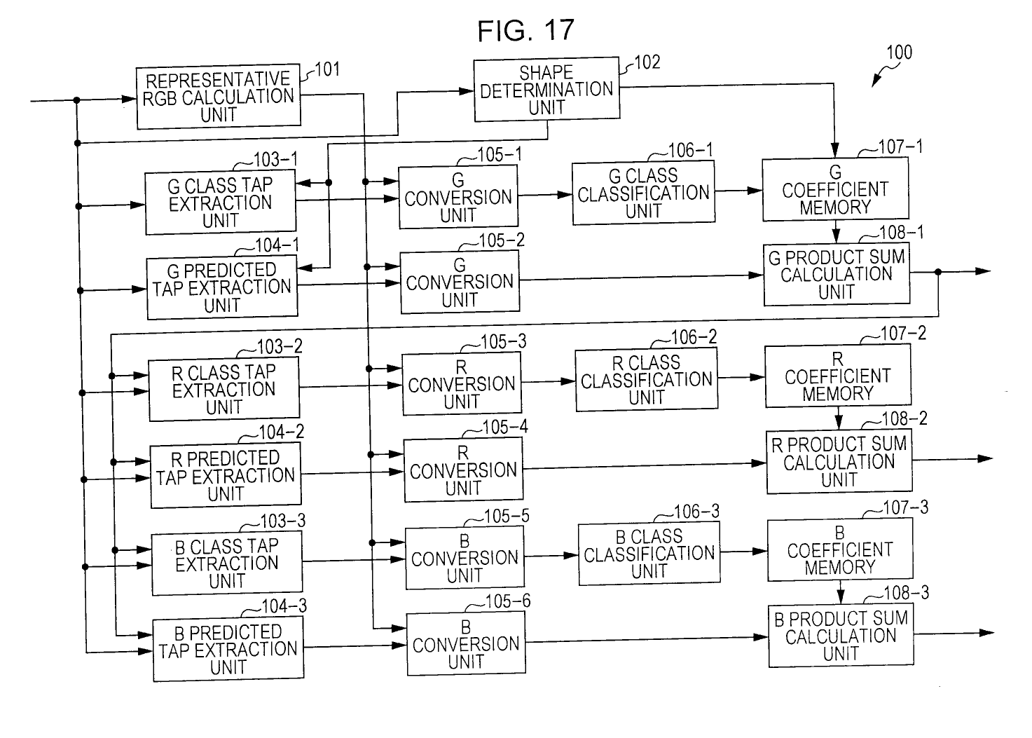

2. Second Embodiment: Image Processing Apparatus (FIGS. 17 to 22)

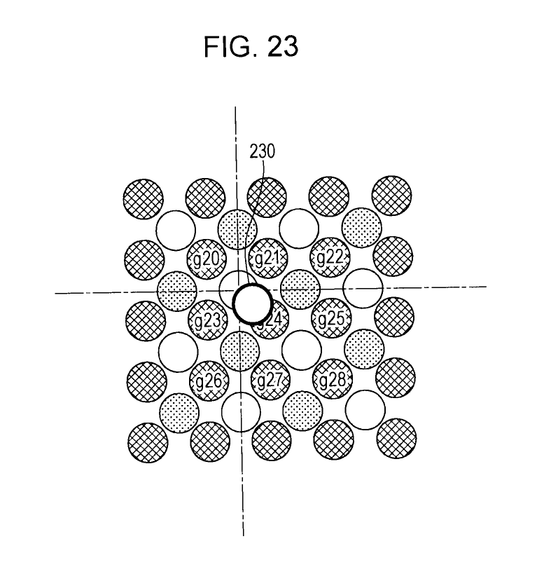

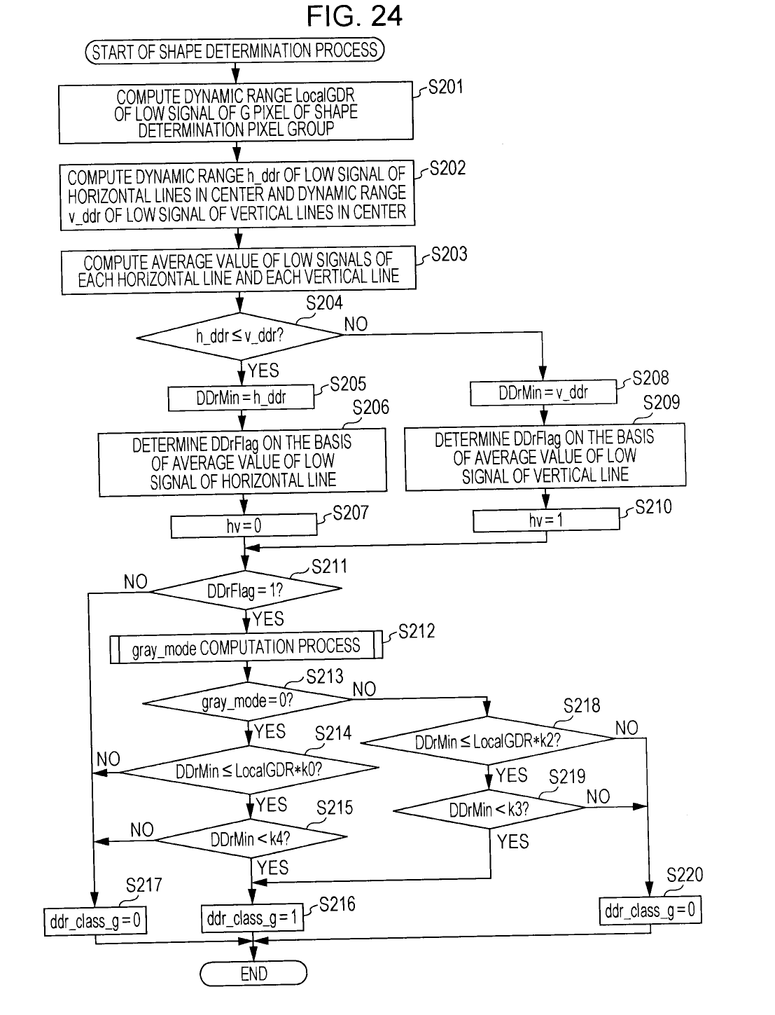

3. Application in another pixel array (FIGS. 23 and 24)

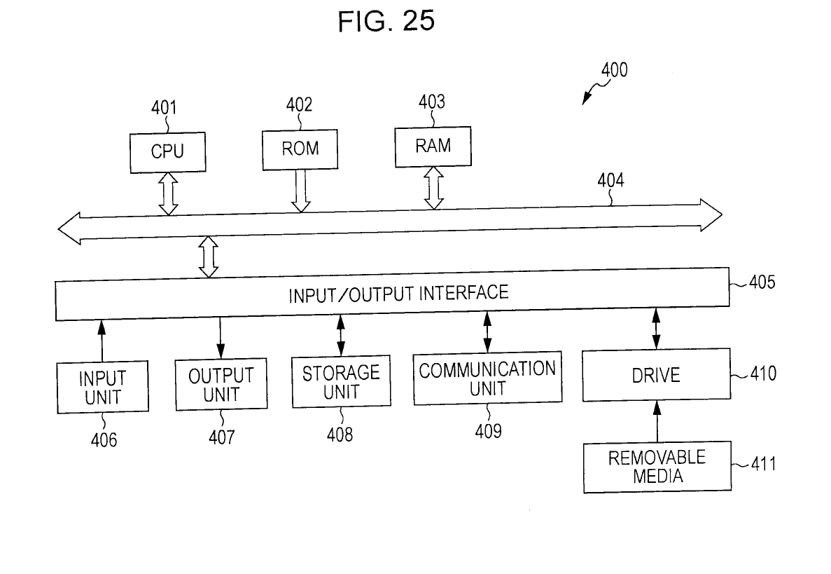

4. Third Embodiment: Computer (FIG. 25)

### FIRST EMBODIMENT

### Configuration Example of First Embodiment of Image Processing Apparatus

FIG. 1 is a block diagram that shows a configuration example of a first embodiment of an image processing apparatus to which the present disclosure has been applied.

An image processing apparatus 10 in FIG. 1 is configured by a shape determination unit 11, a G interpolation unit 12, a G interpolation unit 13, a selection unit 14, a delay unit 15, an R creation unit 16 and a B creation unit 17. The image processing apparatus 10 performs a demosaicing process that converts low signals, which have, as signals of each pixel, of an image, color signals that have been allocated to the pixels, into an image signal that has a signal of all of the red (R), green (G) and blue (B) pixels that correspond to the low signals.

More specifically, low signals that are captured by a single panel image sensor that is not shown in the drawings are input to the shape determination unit 11 of the image processing apparatus 10. Additionally, in this instance, the pixel array of the single panel image sensor is set as a Bayer array. Among the low signals, the shape determination unit 11 determines whether or not the shapes of the low signals of pixels to which colors other than green have been allocated (hereinafter, referred to as G interpolation pixels), are wedge shapes on the basis of the low signals. The shape determination unit 11 supplies determination results to the G interpolation unit 12 and the selection unit 14.

The low signals are input to the G interpolation unit 12 from the single panel image sensor that is not shown in the drawings. The G interpolation unit 12 creates green image signals of the G interpolation pixels on the basis of the determination results that are supplied from the shape determination unit 11 using only the low signals of pixels among the low signals to which green has been allocated (hereinafter, referred to as G pixels). The G interpolation unit 12 supplies the green image signals of the G interpolation pixels and the low signals of the G pixels to the selection unit 14 as green image signals of an image that corresponds to the low signals.

The low signals are input to the G interpolation unit 13 from the single panel image sensor that is not shown in the drawings. The G interpolation unit 13 interpolates the green image signals of the G interpolation pixels using the low signals through a DLMMSE technique. The G interpolation unit 13 supplies the green image signals of the G interpolation pixels and the low signals of the G pixels to the selection unit 14 as green image signals of an image that corresponds to the low signals.

The selection unit 14 selects the green image signals that are supplied from the G interpolation unit 12 or the green image signals that are supplied from the G interpolation unit 13 on the basis of the determination results that are supplied from the shape determination unit 11. In addition to supplying the selected green image signals to the R creation unit 16 and the B creation unit 17, the selection unit 14 outputs the selected green image signals.

The low signals are input to the delay unit 15 from the single panel image sensor that is not shown in the drawings. The delay unit 15 delays the input low signals by a predetermined period of time and supplies the input low signals to the R creation unit 16 and the B creation unit 17.

The R creation unit 16 creates a virtual color difference (R−G) for each pixel in the low signals to which colors other than red have been allocated (hereinafter, referred to as R interpolation pixels), on the basis of the low signals that are supplied from the delay unit 15 and the green image signals that are supplied from the selection unit 14. The R creation unit 16 creates a red image signal for each R interpolation pixel on the basis of the green image signals and the virtual color difference (R−G). The R creation unit 16 outputs the red image signals of the R interpolation pixels and the low signals of pixels to which red has been allocated (hereinafter, referred to as red pixels) as red image signals of an image that corresponds to the low signals.

The B creation unit 17 creates a virtual color difference (B−G) for each pixel in the low signals to which, colors other than blue have been allocated (hereinafter, referred to as B interpolation pixels), on the basis of the low signals that are supplied from the delay unit 15 and the green image signals that are supplied from the selection unit 14. The B creation unit 17 creates a blue image signal for each B interpolation pixel on the basis of the green image signals and the virtual color differences (B−G). The B creation unit 17 outputs the blue image signals of the B interpolation pixels and the low signals of pixels to which blue has been allocated (hereinafter, referred to as blue pixels) as blue image signals of an image that corresponds to the low signals.

### Example of Wedge-Shaped Low Signals

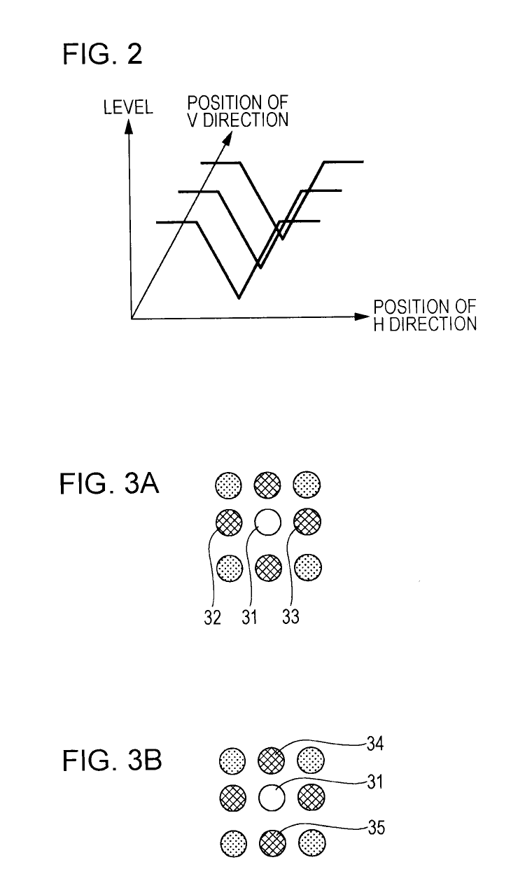

FIG. 2 is a view that shows an example of wedge-shaped low signals, the shapes of which are determined to be wedge shapes by the shape determination unit 11 in FIG. 1.

Additionally, in FIG. 2, the axis of an X direction (a width direction) represents a position in an H direction of pixels that correspond to the low signals, and the axis of a Y direction (a longitudinal direction) represents a position in a V direction thereof. In addition, the axis of a Z direction (a height direction) represents a level of a low signal.

As shown in FIG. 2, for example, in a case in which, among pixels that are lined up in the H direction, the level of the low signal in a single pixel falls suddenly, the shape determination unit 11 determines that the shape of the low signals is a wedge shape in the H direction. Illustration in the drawings has been omitted, but in the same manner with respect to the V direction, in a case in which, among pixels that are lined up in the V direction, the level of the low signal in a single pixel falls suddenly, the shape determination unit 11 determines that the shape of the low signals is a wedge shape in the V direction.

In the manner mentioned above, in a case in which it is determined that the shape of the low signals is a wedge shape in either the H direction or the V direction, that is, in a case in which, among pixels that are lined up in either the H direction or the V direction, the level of the low signal in a single pixel falls suddenly, decolorization is generated. That is, the average value of a color difference with peripheral pixels of a pixel in which the level of the low signal falls suddenly decreases by the original color difference in the pixel. Therefore, when a green image signal of the pixel is interpolated with a DLMMSE technique, an interpolation value of the green image signal rises by one point only. Accordingly, there is a tendency for zipper noise to be generated.

Therefore, the selection unit 14 does not select the green image signals from the G interpolation unit 13 in a case in which a determination result that is supplied from the shape determination unit 11 is a determination result to the effect that the shape of the low signals is a wedge shape in either the H direction or the V direction, and selects the green image signals from the G interpolation unit 12.

### Description of Process of G Interpolation Unit 12

FIGS. 3A and 3B are views that describe processes of the G interpolation unit 12 in FIG. 1.

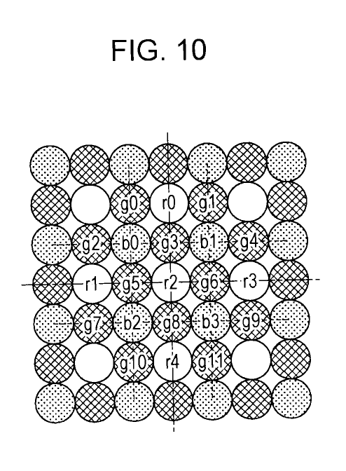

In FIGS. 3A and 3B, the circles to which diagonal lines have been added in two directions represent G pixels, the white circles represent R pixels, and the circles to which polka dots have been added represent B pixels. This also applies in FIGS. 10 and 23 that will be mentioned later.

In a case in which it has been determined that the shape of the low signals of a G interpolation pixel 31 is a wedge shape in the V direction as shown in FIG. 3A, the G interpolation unit 12 creates the green image signal of the G interpolation pixel 31 using the low signal of a G pixel 32 and a G pixel 33, which are adjacent to the G interpolation pixel 31 in the H direction. For example, the G interpolation unit 12 sets the average value of the low signals of the G pixel 32 and the G pixel 33 as the green image signal of the G interpolation pixel 31.

In addition, in a case in which it has been determined that the shape of the low signal of a G interpolation pixel 31 is a wedge shape in the H direction as shown in FIG. 3B, the G interpolation unit 12 creates the green image signal of the G interpolation pixel 31 using the low signal of a G pixel 34 and a G pixel 35, which are adjacent to the G interpolation pixel 31 in the V direction. For example, the G interpolation unit 12 sets the average value of the low signals of the G pixel 34 and the G pixel 35 as the green image signal of the G interpolation pixel 31.

In the above-mentioned manner, since the G interpolation unit 12 creates green image signals of the G interpolation pixels using only the low signals of the G pixels, the green image signals of the G interpolation pixels are not influenced by the effects of the low signals of R pixels and B pixels. Therefore, zipper noise is not generated, but the resolution deteriorates.

Accordingly, the selection unit 14 selects the green image signals that are created by the G interpolation unit 12 only in a case in which the shape of the low signals is a wedge shape in either the H direction or the V direction in which there is a tendency for zipper noise to be generated. As a result of this configuration, it is possible to reduce zipper noise in the image signal. In addition, it is possible to improve the resolution in the image signal.

### Configuration Example of G Interpolation Unit 13

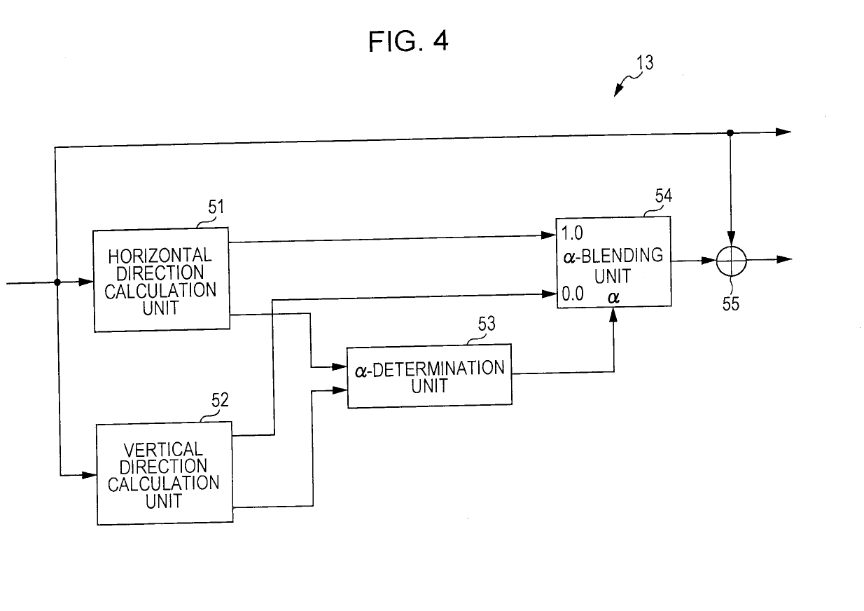

FIG. 4 is a block diagram that shows a configuration example of the G interpolation unit 13 in FIG. 1.

The G interpolation unit 13 in FIG. 4 is configured by a horizontal direction calculation unit 51, a vertical direction calculation unit 52, an α-determination unit 53, an α-blending unit 54 and an addition unit 55.

The horizontal direction calculation unit 51 of the G interpolation unit 13 computes candidates for color differences (B−G, R−G) and a weighting coefficient in the H direction of the G interpolation pixels on the basis of low signals that are input from the single panel image sensor that is not shown in the drawings. The horizontal direction calculation unit 51 supplies the candidates for color differences (B−G, R−G) in the H direction to the α-blending unit 54, and supplies the weighting coefficient in the H direction to the α-determination unit 53.

The vertical direction calculation unit 52 computes candidates for color differences (B−G, R−G) and a weighting coefficient in the V direction of the G interpolation pixels on the basis of low signals that are input from the single panel image sensor that is not shown in the drawings. The vertical direction calculation unit 52 supplies the candidates for color differences (B−G, R−G) in the V direction to the α-blending unit 54, and supplies the weighting coefficient in the V direction to the α-determination unit 53.

The α-determination unit 53 determines α of the α-blending in the α-blending unit 54 using the following Equation (1) on the basis of the weighting coefficient in the H direction that is supplied from the horizontal direction calculation unit 51 and the weighting coefficient in the V direction that is supplied from the vertical direction calculation unit 52, and supplies α to the α-blending unit 54.

$$α = \frac{Wv}{Wv + W h} \qquad ( 1 )$$

In Equation (1), Wh represents the weighting coefficient in the H direction, and Wv represents the weighting coefficient in the V direction.

The α-blending unit 54 α-blends the candidates for color differences (B−G, R−G) in the H direction that are supplied from the horizontal direction calculation unit 51 and the candidates for color differences (B−G, R−G) in the V direction that are supplied from the vertical direction calculation unit 55 using α that is supplied from the α-determination unit 53. When α is 1, an α -blending result is the candidates for color differences (B−G, R−G) in the H direction, and when α is 0, an α-blending result is the candidates for color differences (B−G, R−G) in the V direction. The α-blending unit 54 supplies the α-blending results to the addition unit 55.

The addition unit 55 adds the low signals of the G interpolation pixels that are input from the single panel image sensor that is not shown in the drawings and the α-blending results, and supplies addition results to the selection unit 14 in FIG. 1 as the green image signals of the G interpolation pixels. Additionally, the low signals of the G pixels that are input from the single panel image sensor that is not shown in the drawings are output to the selection unit 14 without change as the green image signals of the G pixels.

### Configuration Example of Horizontal Direction Calculation Unit

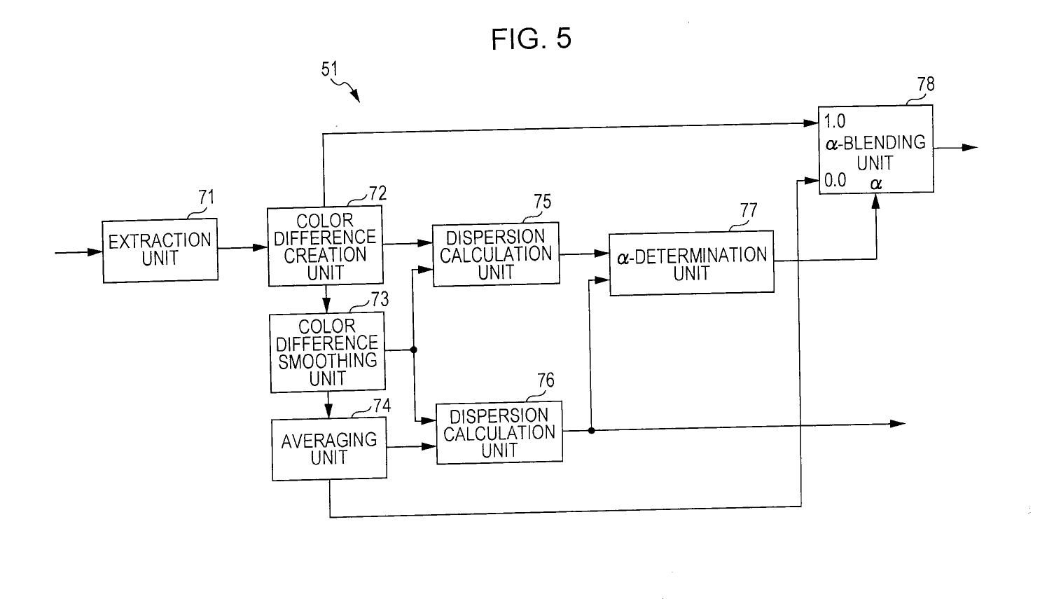

FIG. 5 is a block diagram that shows a configuration example of the horizontal direction calculation unit 51 in FIG. 4.

The horizontal direction calculation unit 51 in FIG. 5 is configured by an extraction unit 71, a color difference creation unit 72, a color difference smoothing unit 73, an averaging unit 74, a dispersion calculation unit 75, a dispersion calculation unit 76, an α-determination unit 77, and an α-blending unit 78.

The extraction unit 71 of the horizontal direction calculation unit 51 extracts the low signals of a G interpolation pixel group that is formed from a total of 11 pixels which are lined up with the G interpolation pixel as the center thereof and five pixels on each side thereof in the H direction, from the low signals that are input from the single panel image sensor that is not shown in the drawings, and supplies the low signals of the G interpolation pixel group to the color difference creation unit 72.

Among the low signals of the G interpolation pixel group that are supplied from the extraction unit 71, the color difference creation unit 72 interpolates the color differences (B−G, R−G) of the low signals of a central pixel of three continuous pixels in order from an end using the low signals of the three pixels. More specifically, the color difference creation unit 72 selects three continuous pixels in order from an end, derives color differences (B−G, R−G) in the low signals of adjacent pixels among the three pixels, and for example, averages the result.

The color difference creation unit 72 supplies nine color differences that are obtained as a result of the abovementioned process to the color difference smoothing unit 73. In addition, among the nine color differences, the color difference creation unit 72 supplies five color differences that correspond to pixels which are lined up with the G interpolation pixel as the center thereof and two pixels on each side thereof in the H direction, to the dispersion calculation unit 75. Furthermore, the color difference creation unit 72 supplies a color difference that corresponds to the G interpolation pixel to the α-blending unit 78.

The color difference smoothing unit 73 performs smoothing of the color differences by deriving the average values of five continuous color differences among the nine color differences that are supplied from the color difference creation unit 72 in order from an end. The color difference smoothing unit 73 supplies the smoothed values of the five color differences that are obtained as a result of this process to the averaging unit 74, the dispersion calculation unit 75 and the dispersion calculation unit 76.

The averaging unit 74 derives the average value of the smoothed values of the five color differences that are supplied from the color difference smoothing unit 73, and supplies the average value to the dispersion calculation unit 76 and the α-blending unit 78.

The dispersion calculation unit 75 derives a dispersion value (a high frequency component) of the five color differences that are supplied from the color difference creation unit 72 and the smoothed values of the five color differences that are supplied from the color difference smoothing unit 73. The dispersion calculation unit 75 supplies the derived dispersion value to the α-determination unit 77.

The dispersion calculation unit 76 derives a dispersion value (a low frequency component) of the smoothed values of the five color differences that are supplied from the color difference smoothing unit 73, and the average value that is supplied from the averaging unit 74. In addition to supplying the dispersion value to the α-determination unit 77, the dispersion calculation unit 76 supplies the dispersion value to the α-determination unit 53 in FIG. 4 as a weighting coefficient in the H direction.

The α-determination unit 77 determines αof the α-blending in the α-blending unit 78 using the following Equation (2) on the basis of the dispersion value that is supplied from the dispersion calculation unit 75 and the dispersion value that is supplied from the dispersion calculation unit 76 and supplies α to the α-blending unit 78.

$$α = \frac{Vg}{V + Vg} \qquad ( 2 )$$

In Equation (2), V represents the dispersion value that is supplied from the dispersion calculation unit 75, and Vg represents the dispersion value that is supplied from the dispersion calculation unit 76.

The α-blending unit 78 α-blends the color difference that corresponds to the G interpolation pixel that is supplied from the color difference creation unit 72 and the average value that is supplied from the averaging unit 74 using α that is supplied from the α-determination unit 77. When α is 1, an α-blending result is the color difference that corresponds to the G interpolation pixel, and when α is 0, an α-blending result is the average value. The α-blending unit 54 supplies the α-blending result to the α-blending unit 54 in FIG. 4 as candidates for color differences (B−G, R−G) of the G interpolation pixel in the H direction.

Additionally, illustration in the drawings has been omitted, but the configuration of the vertical direction calculation unit 52 is the same as the configuration of the horizontal direction calculation unit 51 except for the fact that instances of the H direction are substituted with the V direction.

### Description of the Process of the Horizontal Direction Calculation Unit

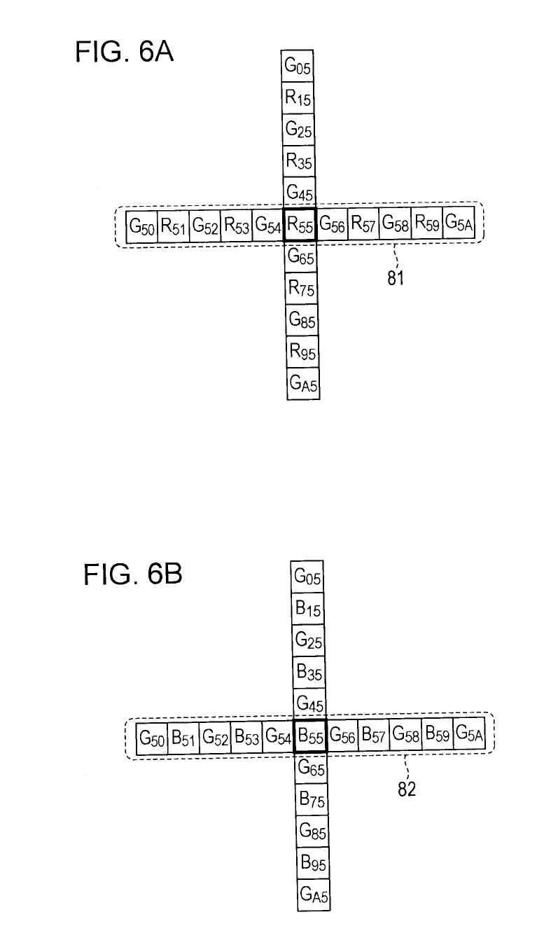

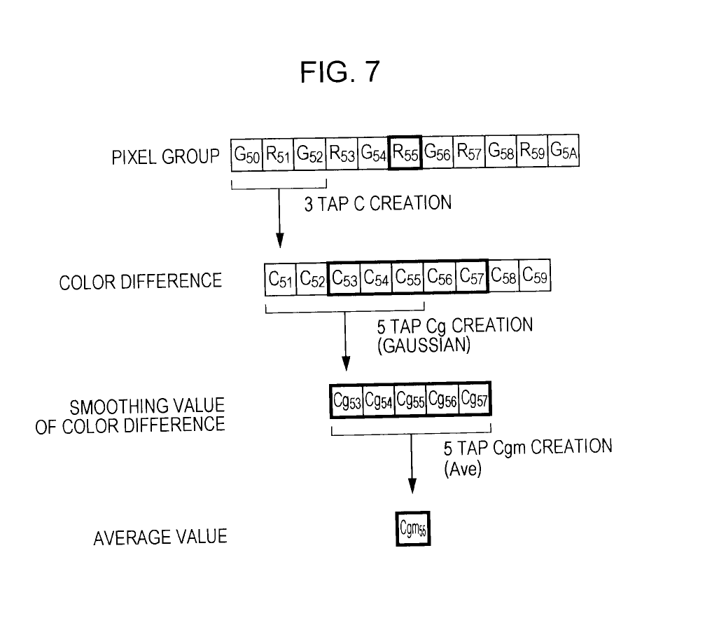

FIGS. 6A, 6B and 7 are views that describe processes of the horizontal direction calculation unit 51 in FIG. 5.

In FIGS. 6A, 6B and 7, the squares represent pixels.

As shown in FIG. 6A, in a case in which the G interpolation pixel is an R pixel R₅₅, the extraction unit 71 sets a total of 11 pixels of a G pixel G₅₀, an R pixel R₅₁a, G pixel G₅₂, an R pixel R₅₃, a G pixel G₅₄, the R pixel R₅₅, a G pixel G₅₆, an R pixel R₅₇, a G pixel G₅₈, an R pixel R₅₉, and a G pixel G_{5A}, which are lined up with the R pixel R₅₅ as the center thereof and five pixels on each side thereof in the H direction as a G interpolation pixel group 81. The extraction unit 71 extracts the low signals of the G interpolation pixel group 81 from the input low signals.

In addition, as shown in FIG. 6B, in a case in which the G interpolation pixel is a B pixel B₅₅, the extraction unit 71 sets a total of 11 pixels of a G pixel G₅₀, a B pixel B₅₁, a G pixel G₅₂, a B pixel B₅₃, a G pixel G₅₄, the B pixel B₅₅, and a G pixel G₅₆, a B pixel B₅₇, a G pixel G₅₈, a B pixel B₅₉, and a G pixel G_{5A}, which are lined up with the B pixel B₅₅ as the center thereof and five pixels on each side thereof in the H direction as a G interpolation pixel group 82. The extraction unit 71 extracts the low signals of the G interpolation pixel group 82 from the input low signals.

Among the low signals of the G interpolation pixel group 81, the color difference creation unit 72 interpolates the color difference (R−G) of the low signal of a central pixel of three continuous pixels in order from an end using the low signals of the three pixels.

More specifically, firstly, the color difference creation unit 72 derives a color difference C₅₁ using the low signals of the three continuous pixels of the G pixel G₅₀, the R pixel R₅₁ and the G pixel G₅₂. Next, the color difference creation unit 72 derives a color difference C₅₂ using the low signals of the three continuous pixels of the R pixel R₅₁, the G pixel G₅₂ and the R pixel R₅₃. In the same manner, the color difference creation unit 72 derives color differences C₅₃, C₅₄, C₅₅, C₅₆, C₅₇, C₅₈ and C₅₉ in order using the three continuous pixels of G pixel G₅₂, the R pixel R₅₃ and the G pixel G₅₄, the R pixel R₅₃, the G pixel G₅₄ and the R pixel R₅₅, the G pixel G₅₄, the R pixel R₅₅ and the G pixel G₅₆, the R pixel R₅₅, the G pixel G₅₆ and the R pixel R₅₇, the G pixel G₅₆, the R pixel R₅₇ end the G pixel G₅₈, the R pixel R₅₇, the G pixel G₅₈ and the R pixel R₅₉, and the G pixel G₅₈, the R pixel R₅₉ and the G pixel G_{5A}.

The color difference smoothing unit 73 performs smoothing of the color differences by deriving the average values of five continuous color differences among the color differences C₅₁ to C₅₉ using a Low Pass filter (LPF).

More specifically, firstly, the color difference smoothing unit 73 derives the average value of the five continuous color differences C₅₁ to C₅₅ as a smoothed value Cg₅₃. Next, the color difference smoothing unit 73 derives the average value of the five continuous color differences C₅₂ to C₅₆ as a smoothed value Cg₅₄. In the same manner, the color difference smoothing unit 73 derives the average values of the five continuous color differences C₅₃ to C₅₇, color differences C₅₄ to C₅₈, and color differences C₅₅ to C₅₉ as smoothed values Cg₅₅, Cg₅₆, and Cg₅₇.

The averaging unit 74 derives the average value Cgm₅₅ of the five smoothed values Cg₅₃ to Cg₅₇.

The dispersion calculation unit 75 derives a dispersion value V₅₅ of the five color differences C₅₃ to C₅₇ that, among the nine color differences color differences C₅₁ to C₅₉ that are derived in the abovementioned manner, correspond to the R pixel R₅₃, the G pixel G₅₄, the R pixel R₅₅, the G pixel G₅₆ and the R pixel R₅₇ which are lined up with the R pixel R₅₅ as the center thereof and two pixels on each side thereof in the H direction, and the five smoothed values Cg₅₃ to Cg₅₇. The dispersion calculation unit 76 derives a dispersion value Vg₅₅ of the five smoothed values Cg₅₃ to Cg₅₇ and the average value Cgm₅₅, and sets the value as the weighting coefficient in the H direction.

The α-determination unit 77 determines α on the on the basis of the dispersion value V₅₅ and the dispersion value Vg₅₅. The α-blending unit 78 α-blends the color difference C₅₅ and the average value Cgm₅₅ that correspond to the R pixel R₅₅ on the basis of α, and sets the α-blending result as a candidate Ch₅₅ for color difference (R−G) in the H direction of the R pixel R₅₅.

Since the processes of the horizontal direction calculation unit 51 of a case in which the G interpolation pixel is tine B pixel B₅₅ are the same as the above-mentioned processes of a case in which the G interpolation pixel is the R pixel R₅₅, description thereof will be omitted.

Additionally, the number of pixels that is extracted by the extraction unit 71 and the number of color differences that are smoothed by the color difference smoothing unit 73 are not limited to the abovementioned numbers.

### Description of Processes of Image Processing Apparatus

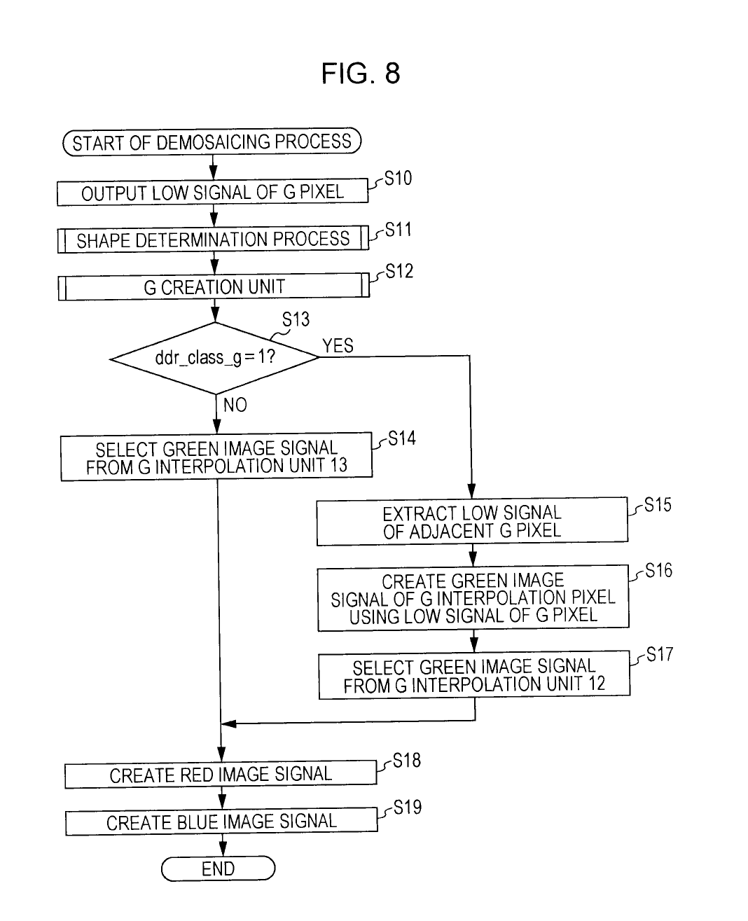

FIG. 8 is a flowchart that describes a demosaicing process of the image processing apparatus 10 in FIG. 1. The demosaicing process is, for example, initiated when low signals, which are captured by the single panel image sensor that is not shown in the drawings, are input into the image processing apparatus 10.

In Step S10 in FIG. 8, among the input low signals, the G interpolation unit 12 and the G interpolation unit 13 of the image processing apparatus 10 output the low signals of G pixels to the selection unit 14 as green image signals of the G pixels.

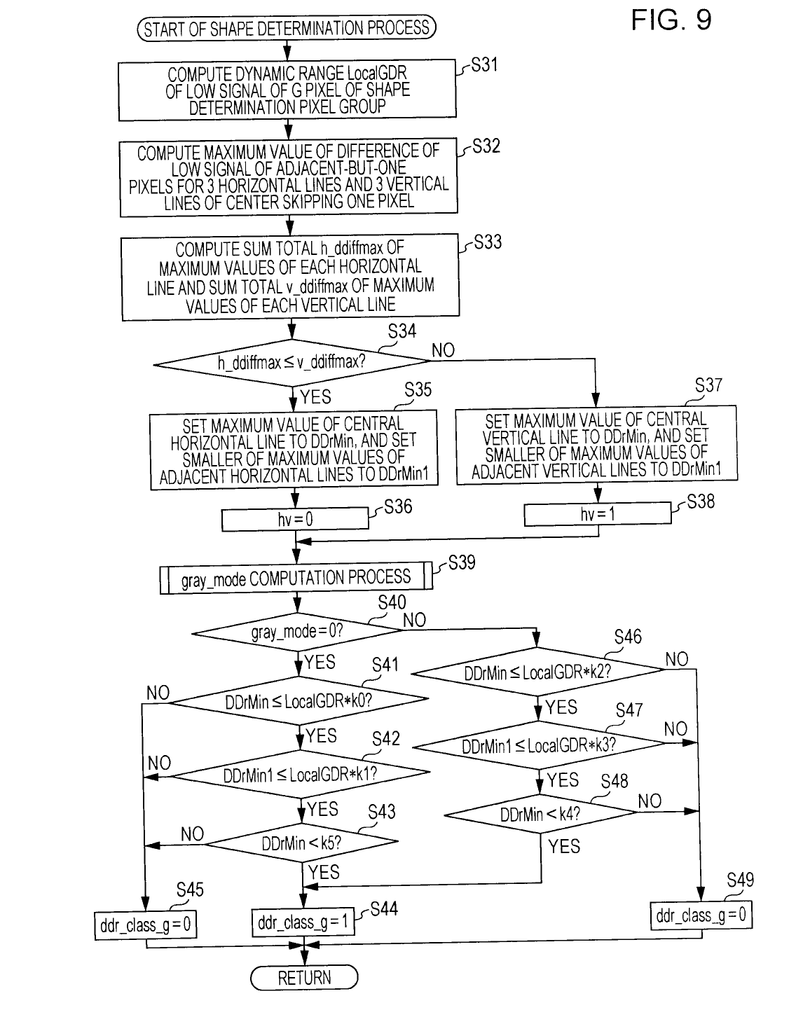

The processes of Steps S11 to S17 are performed for each G interpolation pixel. In Step S11, the shape determination unit 11 performs a shape determination process that determines whether or not the shape of the low signals of the G interpolation pixel is a wedge shape. The details of the shape determination process will be described with reference to FIG. 9 which will be described later.

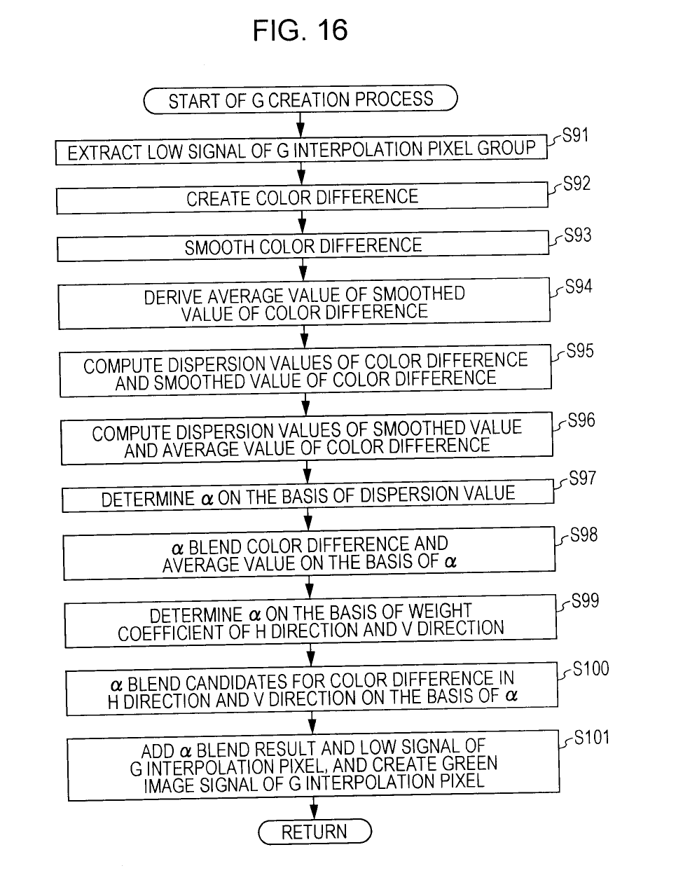

In Step S12, the G interpolation unit 13 performs a G creation process that creates the green image signals of the G interpolation pixel using the low signals. The details of the G creation process will be described with reference to FIG. 16 which will be described later.

In Step S13, the G interpolation unit 12 determines whether or not a ddr_class_g that represents a determination result that is supplied from the shape determination unit 11, is 1, which represents the fact that the shape of the low signals is a wedge shape. In a case in which it is determined in Step S13 that the ddr_class_g is not 1, the process proceeds to Step S14.

In Step S14, the selection unit 14 selects the green image signals from the G interpolation unit 13. In addition to supplying the selected green image signals to the R creation unit 16 and the B creation unit 17, the selection unit 14 outputs the selected green image signals, and the process proceeds to Step S18.

Meanwhile, in a case in which it is determined in Step S13 that the ddr_class_g is 1, the process proceeds to Step S15. In Step S13, the G interpolation unit 12 extracts the low signals of two G pixels that are adjacent to the G interpolation pixel in a direction (either the H direction or the V direction) of the wedge shape that was determined by the shape determination process of Step S11, and a directions that is perpendicular thereto.

In Step S16, the G interpolation unit 12 creates the green image signals of the G interpolation pixel using the extracted low signals of the G pixels, and supplies the green image signals to the selection unit 14.

In Step S17, the selection unit 14 selects the green image signals from the G interpolation unit 12. In addition to supplying the selected green image signals to the R creation unit 16 and the B creation unit 17, the selection unit 14 outputs the selected green image signals, and the process proceeds to Step S18.

In Step S18, the R creation unit 16 creates a red image signal for each R interpolation pixel on the basis of the green image signals that are supplied from the selection unit 14 and the virtual color difference (R−G). The color difference (R−G) is created for each R interpolation pixel on the basis of the low signals that are delayed by the delay unit 15 and the green image signals. The R creation unit 16 outputs the red image signals of the R interpolation pixels and the low signals of the R pixels as the red image signals of an image that corresponds to the low signals.

In Step S19, the B creation unit 17 creates a blue image signal for each B interpolation pixel on the basis of the green image signals that are supplied from the selection unit 14 and the virtual color difference (B−G). The color difference (B−G) is created for each B interpolation pixel on the basis of the low signals that are supplied from the delay unit 15 and the green image signals. The B creation unit 17 outputs the blue image signals of the B interpolation pixels and the low signals of the B pixels as the blue image signals of an image that corresponds to the low signals. Further, the process ends.

FIG. 9 is a flowchart that describes a shape determination process of Step S11 in FIG. 8 in detail.

In Step S31 in FIG. 9, the shape determination unit 11 computes a dynamic range LocalGDR of the low signals of the G pixels of a shape determination pixel group that is formed from the G interpolation pixel and the peripheral pixels thereof on the basis of the input low signals.

For example, as shown in FIG. 10, in a case in which the G interpolation pixel is an R pixel r2, the shape determination unit 11 extracts a total of 21 pixels of a set of 5×3 pixels with the R pixel r2 as the center thereof, and three pixels of the rows above and below the set of 5×3 pixels with the position in the H direction of the pixel r2 as the center thereof as the shape determination pixel group. Further, among the shape determination pixel group, the shape determination unit 11 detects a maximum value and a minimum value of the low signals of 12 G pixels g0 to g11, and computes a subtracted value in which the minimum value has been subtracted from the maximum value as the dynamic range LocalGDR.

In Step S32, the shape determination unit 11 computes a maximum value of differences in the low signals of adjacent-but-one pixels for three horizontal lines (lines in the H direction) and three vertical lines (lines in the V direction) in the center of the shape determination pixel group.

More specifically, the shape determination unit 11 computes maximum values h_ddifmax0 to h_ddiffmax2 for three horizontal lines in the center of the shape determination pixel group using the following Equation (3).

h_ddiffmax0=(maximum value of |g2−g3|,|b0−b1|,|g3−g4|)

h_ddiffmax1=(maximum value of |r1−r2|,|g5−g6 |,|r2−r3|)

h_ddiffmax2=(maximum value of |g7−g8|,|b2−b3|,|g8−g9|) (3)

In addition, the shape determination unit 11 computes maximum values v_ddiffmax0 to v_ddiffmax2 for three vertical lines in the center of the shape determination pixel group using the following Equation (4).

v_diffmax0=(maximum value of |g0−g5|,|b0−b2 |,|g5−g10|)

v_ddiffmax1=(maximum value of |r0−r2|,|g3−g8|,|r2−r4|)

v_ddiffmax2=(maximum value of |g1−g6|,|b1−b3|,|g6−g11|) (4)

In Step S33, the shape determination unit 11 computes a sum total h_ddiffmax of the maximum values of each horizontal line h_ddiffmax0 to h_ddiffmax2, and computes a sum total v_ddiffmax of the maximum values of each vertical line v_ddiffmax0 to v_ddiffmax2.

In Step S34, the shape determination unit 11 determines whether or not the sum total h_ddiffmax is less than or equal to the sum total v_ddiffmax. In a case in which it is determined in Step S34 that the sum total h_ddiffmax is less than or equal to the sum total v_ddiffmax, the process proceeds to Step S35.

In Step S35, the shape determination unit 11 sets the maximum value h_ddiffmax1 of the central horizontal line in which the G interpolation pixel is present as DDrMin, and among the maximum values h_ddiffmax0 and h_ddiffmax2 of the horizontal lines that are adjacent to the abovementioned horizontal line, sets the smaller of the two as DDrMin1. Additionally, in a case in which the maximum value h_ddiffmax0 and the maximum value h_ddiffmax2 are the same, the shape determination unit 11 sets the shared value as DDrMin1.

In Step S36, the shape determination unit 11 sets hv, which represents a direction of the determined wedge shape, to 0, which represents the V direction. hv is supplied to the G interpolation unit 12, and is used by the G interpolation unit 12 when extracting the low signals in Step S15 in FIG. 8.

Meanwhile, in a case in which it is determined in Step S34 that the sum total h_ddiffmax is not less than or equal to the sum total v_ddiffmax, the process proceeds to Step S37.

In Step S37, the shape determination unit 11 sets the maximum value v_ddiffmax1 of the central vertical line in which the G interpolation pixel is present as DDrMin, and among the maximum values v_ddiffmax0 and v_ddiffmax2 of the vertical lines that are adjacent to the abovementioned vertical line, sets the smaller of the two as DDrMin1. Additionally, in a case in which the maximum value v_ddiffmax0 and the maximum value v_ddiffmax2 are the same, the shape determination unit 11 sets the shared value as DDrMin1.

In Step S38, the shape determination unit 11 sets hv, which represents a direction of the determined wedge shape, to 1, which represents the H direction. hv is supplied to the G interpolation unit 12, and is used by the G interpolation unit 12 when extracting the low signals in Step S15 in FIG. 8.

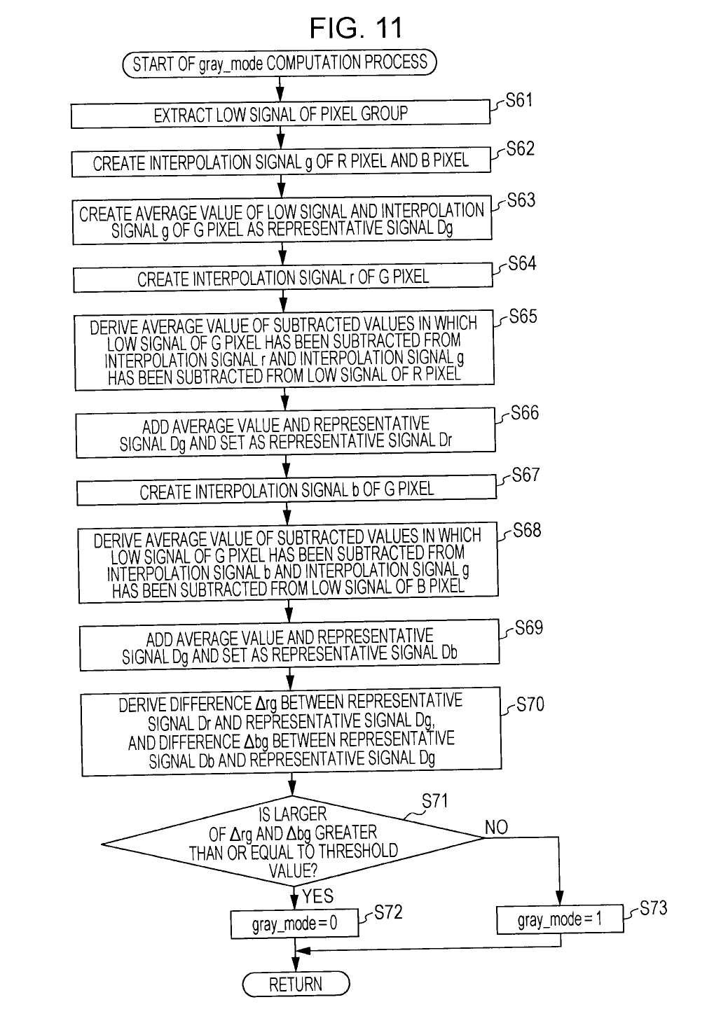

After the process of either Step S36 or Step S38, the process proceeds to Step S39. In Step S39, the shape determination unit 11 performs a gray_mode computation process that computes a gray_mode that represents whether or not a color that the low signals represent is grey. The details of the gray_mode computation process will be described with reference to FIG. 11 which will be described later.

In Step S40, the shape determination unit 11 determines whether or not the gray_mode that was computed by the gray_mode computation process is 0, which represents the fact that a color that the low signals represent is not grey. In a case in which it is determined in Step S40 that the gray mode is 0, in Step S41, the shape determination unit 11 determines whether or not DDrMin is less than or equal to k0 of the dynamic range LocalGDR.

In a case in which it is determined in Step S41 that DDrMin is less than or equal to k0 of the dynamic range LocalGDR, the process proceeds to Step S42. In Step S42, the shape determination unit 11 determines whether or not DDrMin1 is less than or equal to k1 of the dynamic range LocalGDR.

In a case in which it is determined in Step S42 that DDrMin1 is less than or equal to k1 of the dynamic range LocalGDR, the process proceeds to Step S43. In Step S43, the shape determination unit 11 determines whether or not DDrMin is smaller than k5. In a case in which it is determined in Step S43 that DDrMin is smaller than k5, the process proceeds to Step S44.

In Step S44, the shape determination unit 11 sets the ddr_class_g as 1, which represents being set as a determination result, of the fact that the shape of the low signals is a wedge shape, and supplies the determination result to the G interpolation unit 12 and the selection unit 14. Further, the process returns to Step S11 in FIG. 8, and proceeds to Step S12.

Meanwhile, in a case in which it is determined in Step S41 that DDrMin is not less than or equal to k0 of the dynamic range LocalGDR, a case in which it is determined in Step S42 that DDrMin1 is not less than or equal to k1 of the dynamic range LocalGDR, or a case in which it is determined in Step S43 that DDrMin is not smaller than k5, the process proceeds to Step S45.

In Step S45, the shape determination unit 11 sets the ddr_class_g to 0, which represents being set as a determination result of the fact that the shape of the low signals is not a wedge shape, and supplies the determination result to the G interpolation unit 12 and the selection unit 14. Further, the process returns to Step S11 in FIG. 8, and proceeds to Step S12.

In addition, in a case in which it is determined in Step S40 that the gray_mode is not 0, the process proceeds to step S46. In Step S46, the shape determination unit 11 determines whether or not DDrMin is less than or equal to k2 of the dynamic range LocalGDR.

In a case in which it is determined in Step S46 that DDrMin is less than or equal to k2 of the dynamic range LocalGDR, the process proceeds to Step S47. In Step S47, the shape determination unit 11 determines whether or not DDrMin1 is less than or equal to k3 of the dynamic range LocalGDR.

In a case in which it is determined in Step S47 that DDrMin1 is less than or equal to k3 of the dynamic range LocalGDR, the process proceeds to Step S48. In Step S48, the shape determination unit 11 determines whether or not DDrMin is smaller than k4. In a case in which it is determined in Step S48 that DDrMin is smaller than k4, the process proceeds to Step S44, and the abovementioned process is performed.

Meanwhile, in a case in which it is determined in Step S46 that DDrMin is not less than or equal to k2 of the dynamic range LocalGDR, a case in which it is determined in Step S47 that DDrMin1 is not less than or equal to k3 of the dynamic range LocalGDR, or a case in which it is determined in Step S48 that DDrMin is not smaller than k4, the process proceeds to Steps S49.

In Step S49, the shape determination unit 11 sets the ddr_class_g to 0, and supplies the determination result to the G interpolation unit 12 and the selection unit 14. Further, the process returns to Step S11 in FIG. 8, and proceeds to Step S12.

Ira the abovementioned manner, the shape determination unit 11 determines the ddr_class_g using a threshold value that differs between a case in which the gray_mode is 1 and a case in which the gray_mode is 0. That is, the share determination unit 11 determines that the shape of the low signals is a wedge shape using the threshold value that depends on whether or not a color that the low signals represent is grey.

FIG. 11 is a flowchart that describes a gray_mode computation process in FIG. 9 in detail.

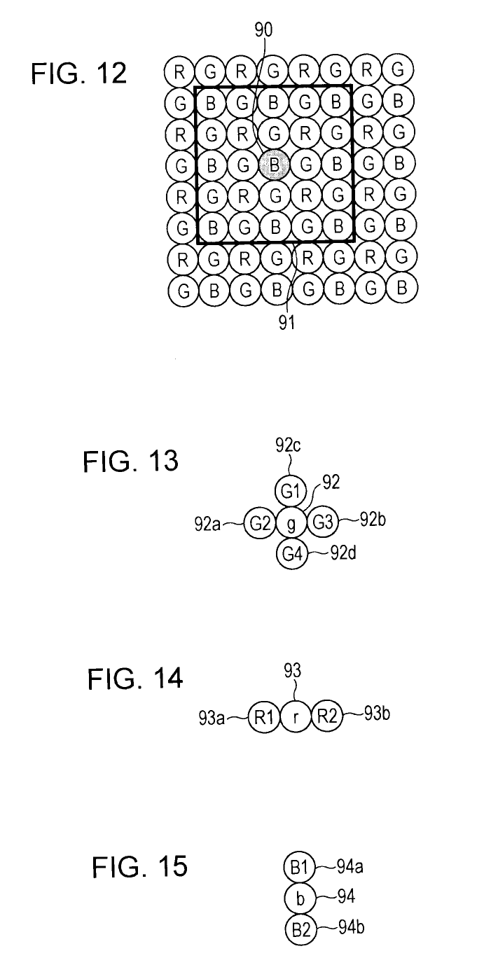

In Stop S61 in FIG. 11, the shape determination unit 11 extracts the low signals of a grey computation pixel group that is formed from the G interpolation pixel and the peripheral pixels thereof. For example, in a case in which the G interpolation pixel is the B pixel 90 in FIG. 12, the shape determination unit 11 extracts the low signals of a grey computation pixel group 91 that is formed from a set 5×5 pixels with the B pixel 90 as the center thereof.

Additionally, in FIG. 12, the circles to which an R has been added represent R pixels, the circles to which a G has been added represent G pixels, and the circles to which a B has been added represent B pixels. This also applies in FIGS. 13 to 15 that will be mentioned later.

In Step S62, the shape determination unit 11 creates an average value of the low signals of the G pixels that are adjacent above, below, to the left and right of the R pixels and the B pixels within the grey computation pixel group as an interpolation signal g of the R pixels and the B pixels. For example, as shown in FIG. 13, the shape determination unit 11 creates an average value of the low signals of G pixels 92a to 92d that are adjacent above, below, to the left and right of a pixel 92, which is a R pixel or a B pixel, as an interpolation signal g of the pixel 92.

In Step S63, the shape determination unit 11 creates an average value of the low signals of the G pixels within the grey computation pixel group and the interpolation signal g as a representative signal Dg.

In Step S64, the shape determination unit 11 creates an average value of the low signals of the R pixels that are adjacent to the left and right of the G pixels within the grey computation pixel group as an interpolation signal r of the G pixels. For example, as shown in FIG. 14, the shape determination unit 11 creates an average value of the low signals of R pixels 93a and 93b that are adjacent to the left and right of a G pixel 93 as an interpolate on signal r of the G pixel 93.

In Step S65, the shape determination unit 11 derives an average value of a subtracted value in which the low signals of the G pixels within the grey computation pixel group have been subtracted from the interpolation signal r within the grey computation pixel group, and a subtracted value in which the interpolation signal g within the grey computation pixel group has been subtracted from the low signals of the R pixels within the grey computation pixel group.

In Step S66, the shape determination unit 11 adds the average value that was derived in Step S65 and the representative signal Dg, and sets the result as a representative signal Dr.

In Step S67, the shape determination unit 11 creates an average value of the low signals of the B pixels that are adjacent above and below the G pixels within the grey computation pixel group as an interpolation signal b of the G pixels. For example, as shown in FIG. 15, the shape determination unit 11 creates an average value of the low signals of B pixels 94a and 94b that are adjacent above and below a G pixel 94 as an interpolation signal r of the G pixel 94.

In Step S68, the shape determination unit 11 derives an average value of a subtracted value in which the low signals of the G pixels within the grey computation pixel group have been subtracted from the interpolation signal b within the grey computation pixel group, and a subtracted value in which the interpolation signal g within the grey computation pixel group has been subtracted from the low signals of the B pixels within the grey computation pixel group.

In Step S69, the shape determination unit 11 adds the average value that was derived in Step S68 and the representative signal Dg, and sets the result as a representative signal Dg.

In Step S70, the shape determination unit 11 derives a difference Δrg between the representative signal Dr and the representative signal Dg, and a difference Δbg between the representative signal Db and the representative signal Dg. In Step S71, the shape determination unit 11 determines whether or not a value of the larger of the differences Δrg and Δbg is greater than or equal to the threshold value.

In a case in which it is determined in Step S71 that a value of the larger of the differences Δrg and Δbg is greater than or equal to the threshold value, the shape determination unit 11 sets the gray_mode to 0 in Step S72. Further, the process returns to Step S39 in FIG. 9, and proceeds to Step S40.

Meanwhile, in a case in which it is determined in Step S71 that a value of the larger of the differences Δrg and Δbg is not greater than or equal to the threshold value, the shape determination unit 11 sets the gray_mode to 1 in Step S73. Further, the process returns to Step S39 in FIG. 9, and proceeds to Step S40.

FIG. 16 is a flowchart that describes a G creation process of Step S12 in FIG. 8 in detail.

The processes of Steps S91 to S98 in FIG. 16 are respectively performed in the horizontal direction calculation unit 51 and the vertical direction calculation unit 52 in FIG. 4, but since the processes of the vertical direction calculation unit 52 are the as the processes of the horizontal direction calculation unit 51 except for the fact that instances of the H direction are substituted with the V direction, only the processes of the horizontal direction calculation unit 51 are described below.

In Step S91, the extraction unit 71 (FIG. 5) of the horizontal direction calculation unit 51 extracts the low signals of the a G interpolation pixel group from the input low signals, and supplies the low signals of the G interpolation pixel group to tine color difference creation unit 72.

In Step S92, the color difference creation unit 72 creates color differences (B−G, R−G) of the low signals in order from an end using the low signals of three continuous pixels among the low signals of the G interpolation pixel group that are supplied from the extraction unit 71. The color difference creation unit 72 supplies nine color differences that are obtained as a result of the abovementioned process to the color difference smoothing unit 73. In addition, among the nine color differences, the color difference creation unit 72 supplies five color differences that correspond to pixels which are lined up with the G interpolation pixel as the center thereof and two pixels on each side thereof in the H direction, to the dispersion calculation unit 75. Furthermore, the color difference creation unit 72 supplies a color difference that corresponds to the G interpolation pixel to the α-blending unit 78.

In Step S93, the color difference smoothing unit 73 performs smoothing of the color differences by deriving the average values of five continuous color differences among the nine color differences that are supplied from the color difference creation unit 72 in order from an end. The color difference smoothing unit 73 supplies the smoothed values of the five color differences that are obtained as a result of this process to the averaging unit 74, the dispersion calculation unit 75 and the dispersion calculation unit 76.

In Step S94, the averaging unit 74 derives the average value of the smoothed values of the five color differences that are supplied from the color difference smoothing unit 73, and supplies the average value to the dispersion calculation unit 76 and the α-blending unit 78.

In step S95, the dispersion calculation unit 75 computes a dispersion value of the five color differences that are supplied from the color difference creation unit 72 and the smoothed values of the five color differences that are supplied from the color difference smoothing unit 73, supplies the dispersion value to the α-determination unit 77.

In Step S96, the dispersion calculation unit 76 computes a dispersion value of the smoothed values of the five color differences that are supplied from the color difference smoothing unit 73, and the average value that is supplied from the averaging unit 74. In addition to supplying the dispersion value to the α-determination unit 77, the dispersion calculation unit 76 supplies the dispersion value to the α-determination unit 53 in FIG. 4 as a weighting coefficient in the H direction.

In Step S57, the α-determination unit 77 determines α of the α-blending in the α-blending unit 73 on the basis of the dispersion value that is supplied from the dispersion calculation unit 75 and the dispersion value that is supplied from the dispersion calculation unit 76, and supplies α to the α-blending unit 78.

In Step S98, the α-blending unit 78 α-blends the color difference that corresponds to the G interpolation pixel that is supplied from the color difference creation unit 72 and the average value that is supplied from the averaging unit 74 on the basis of α that is supplied from the α-determination unit 77. The α-blending unit 54 supplies the α-blending result to the α-blending unit 54 in FIG. 4 as candidates for color differences (B−G, R−G) of the G interpolation pixel in the H direction.

In the vertical direction calculation unit 52, the same processes as the abovementioned processes of Steps S91 to S98 are performed for the V direction, candidates for color differences (B−G, R−G) in the V direction are supplied to the α-blending unit 54, and a weighting coefficient is supplied to the α-determination unit 53.

In Step S99, the α-determination unit 53 determines α of the α-blending in the α-blending unit 54 on the basis of the weighting coefficient in the H direction that is supplied from the horizontal direction calculation unit 51 and the weighting coefficient in the V direction, and supplies α to the α-blending unit 54.

In Step S100, the α-blending unit 54 α-blends the candidates for color differences (B−G, R−G) in the H direction that are supplied from the horizontal direction calculation unit 51 and the candidates for color differences (B−G, R−G) in the V direction that are supplied from the vertical direction calculation unit 52 on the basis of α that is supplied from the α-determination unit 53. The α-blending unit 54 supplies the α-blending results to the addition unit 55.

In Step S101, the addition unit 55 adds the α-blending results and the low signals of the G interpolation pixels, and creates the green image signals of the G interpolation pixels. The addition unit 55 supplies the green image signals of the G interpolation pixels to the selection unit 14 in FIG. 1. Further, the process returns to Step S12 in FIG. 8, and proceeds to Step S13.

In the abovementioned manner, the image processing apparatus 10 creates green image signals using only the low signals of G pixels in a case in which the shape of the low signals is a wedge shape in which there is a tendency for zipper noise to be generated by a demosaicing process that uses a DLMMSE technique. Therefore, it is possible to reduce the image quality deterioration that is referred to as zipper noise in the image signal.

In addition, in a case in which the shape of the low signals of a G interpolation pixel is not a wedge shape, the image processing apparatus 10 creates the green image signal of the G interpolation pixel with a DLMMSE technique. Therefore, it is possible to improve the resolution of the image signal in comparison with a case in which the green image signals of all pixels are created using only the low signals of G pixels.

### SECOND EMBODIMENT

### Configuration Example of Second Embodiment of Image Processing Apparatus

FIG. 17 is a block diagram that shows a configuration example of a second embodiment of an image processing apparatus to which the present disclosure has been applied.

An image processing apparatus 100 in FIG. 17 has a representative RGB calculation unit 101 and a shape determination unit 102. The image processing apparatus 100 includes a G class tap extraction unit 103-1, an R class tap extraction unit 103-2, a B class tap extraction unit 103-3, a G predicted tap extraction unit 104-1, an R predicted tap extraction unit 104-2 and a B predicted tap extraction unit 104-3. In addition, the image processing apparatus 100 has G conversion units 105-1 and 105-2, R conversion units 105-3 and 105-4 and B conversion units 105-5 and 105-6.

The image processing apparatus 100 has a G class classification unit 106-1, an R class classification unit 106-2, a B class classification unit 106-3, a G coefficient memory 107-1, an R coefficient memory 107-2 and a B coefficient memory 107-3. The image processing apparatus 100 has a G product sum calculation unit 108-1, an R product sum calculation unit 108-2 and a B product sum calculation unit 108-3. The image processing apparatus 100 performs a demosaicing process on low signals that are captured by a single panel image sensor that is not shown in the drawings using a class classification adaptive process.

More specifically, the representative RGB calculation unit 101 of the image processing apparatus 100 sets each pixel among pixels that correspond to an image signal that is created by a demosaicing process as a target pixel, which is a pixel in the image that is being targeted, in order. The representative RGB calculation unit 101 calculates representative signals Dr, Db and Dg of a G class tap, an R class tap and a B class tap (to be described in detail later) using the low signals that are input from the single panel image sensor that is not shown in the drawings. More specifically, the representative RGB calculation unit 101 performs the processes of Steps S61 to S69 in FIG. 11 with a pixel group that corresponds to the G class tap, the R class tap and the B class tap in place of the grey computation pixel group.

Additionally, the G class tap is a signal that is used in class classification during creation of the green image signal of a target pixel, and is formed from the low signals of a plurality of pixels that are positioned in the periphery of a position that corresponds to the target pixel. The R class tap is a signal that is used in class classification during creation of the red image signal of a target pixel, and is formed from the low signals and the green image signals of a plurality of pixels that are positioned in the periphery of a position that corresponds to the target pixel. The B class tap is a signal that is used in class classification during creation of the blue image signal of a target pixel, and is formed from the low signals and the green image signals of a plurality of pixels that are positioned in the periphery of a position that corresponds to the target pixel.

In addition, the representative RGB calculation unit 101 calculates representative signals Dr, Db and Dg of a G predicted tap, an R predicted tap and a B predicted tap (to be described in detail later). More specifically, the representative RGB calculation unit 101 performs the processes of Steps S61 to S69 in FIG. 11 with a pixel group that corresponds to the G predicted tap, the R predicted tap and the B predicted tap in place of the grey computation pixel group.

Additionally, the G predicted tap is a signal that is used in the creation of the green image signal of a target pixel, and is formed front the low signals of a plurality of pixels that are positioned in the periphery of a position that corresponds to the target pixel. The R predicted tap is a signal that is used in the creation of the red image signal of a target pixel, and is formed from the low signals and the green image signals of a plurality of pixels that are positioned in the periphery of a position that corresponds to the target pixel. The B predicted tap is a signal that is used in the creation of the blue image signal of a target pixel, and is formed from the low signals and the green image signals of a plurality of pixels that are positioned in the periphery of a position that corresponds to the target pixel.

When creating the representative signals Dr, Db and Dg, instead of the G class tap, the representative RGB calculation unit 101 may be configured to use a pixel group that corresponds to the R class tap, the B class tap, the G predicted tap, or the R predicted tap instead of the G class tap, or a pixel group that includes such a pixel group. That is, the representative RGB calculation unit 101 may be configured to create the representative signals Dr, Db and Dg using the G class tap, the R class tap, the B class tap, the G predicted tap, the R predicted tap or a pixel group that includes the G predicted tap in place of the grey computation pixel group in the processes of Steps S61 to S69 in FIG. 11.

The representative RGB calculation unit 101 supplies the representative signals Dr, Db and Dg of the G class tap to the G conversion unit 105-1, and supplies the representative signals Dr, Db and Dg of the R class tap to the R conversion unit 105-3. In addition, the representative RGB calculation unit 101 supplies the representative signals Dr, Db and Dg of the B class tap to the B conversion unit 105-5.

In addition, the representative RGB calculation unit 101 supplies the representative signals Dr, Db and Dg of the G predicted tap class tap to the G conversion unit 105-2, and supplies the representative signals Dr, Db and Dg of the R predicted tap to the R conversion unit 105-4. In addition, the representative RGB calculation unit 101 supplies the representative signals Dr, Db and Dg of the B predicted tap to the B conversion unit 105-6.

The shape determination unit 102 performs a shape determination process that determines whether or not the shapes of the low signals of pixels that correspond to the target pixel is a wedge shapes on the basis of the low signals that are input from the single panel image sensor that is not shown in the drawings. Except for the fact that the G interpolation pixels are substituted for a pixel that corresponds to the target pixel, the shape determination process is the same as the shape determination process in FIG. 9. The shape determination unit 102 supplies the ddr_class_g, which represents the determination results to the G class tap extraction unit 103-1, the G predicted tap extraction unit 104-1, and the G coefficient memory 107-1.

The G class tap extraction unit 103-1 extracts the G class tap from the low signals that are input from the single panel image sensor that is not shown in the drawings on the basis of the ddr_class_g that is supplied from the shape determination unit 102, and supplies the G class tap to the G conversion unit 105-1.

The R class tap extraction unit 103-2 extracts the R class tap from the low signals that are input from the single panel image sensor that is not shown in the drawings and green image signals that are supplied from the G product sum calculation unit 108-1, and supplies the R class tap to the R conversion unit 105-3. The B class tap extraction unit 103-3 extracts the R class tap from the low signals that are input from the single panel image sensor that is not shown in the drawings and the green image signals that are supplied from the G product sum calculation unit 108-1, and supplies the B class tap to the B conversion unit 105-5.

The G predicted tap extraction unit 104-1 extracts the G predicted tap from the low signals that are input from the single panel image sensor that is not shown in the drawings on the basis of the ddr_class_g that is supplied from the shape determination unit 102, and supplies the G predicted tap to the G conversion unit 105-2.

The R predicted tap extraction unit 104-2 extracts the R predicted tap from the low signals that are input from the single panel image sensor that is not shown in the drawings and the green image signals that are supplied from the G product sum calculation unit 108-1, and supplies the R predicted tap to the R conversion unit 105-4. The B predicted tap extraction unit 104-3 extracts the B predicted tap from the low signals that are input from the single panel image sensor that is not shown in the drawings and the green image signals that are supplied from the G product sum calculation unit 108-1, and supplies the B predicted tap to the B conversion unit 105-6.

The G conversion unit 105-1 performs a G conversion process according to the following Equation (5) with respect to the G class tap that is supplied from the G class tap extraction unit 103-1 using the representative signals Dr, Db and Dg of the G class tap that are supplied from the representative RGB calculation unit 101.

G′=G

R′=R−(Dr−Dg)

B′=B−(Db−Dg) (5)

In Equation (5), G represents the low signals of the G pixels among the G class tap, and G′ represents the low signals of the G pixels after the G conversion process. R represents the low signals of the R pixels among the G class tap, and R′ represents the low signals of the R pixels after the G conversion process. B represents the low signals of the B pixels among the G class tap, and B′ represents the low signals of the B pixels after the G conversion process.

By carrying out this kind of G conversion process, the low signals of the R pixels and the B pixels within the G class tap offset the low signals of the G pixels as a standard. As a result of this configuration, it is possible to remove changes that are a result of differences in color between the pixels of the G class tap. As a result of this, it is possible to improve the correlation between pixels of the G class tap. The G conversion unit 105-1 supplies the G class tap after the G conversion process to the G class classification unit 106-1.

The G conversion unit 105-2 performs the same G conversion process as the G conversion process of the G conversion unit 105-1 with respect to the G predicted tap that is supplied from the G predicted tap extraction unit 104-1 using the representative signals Dr, Db and Dg of the G predicted tap that are supplied from the representative RGB calculation unit 101. The G conversion unit 105-2 supplies the G predicted tap after the G conversion process to the G product sum calculation unit 108-1.

The R conversion unit 105-3 performs an R conversion process according to the following Equation (6) with respect to the R class tap that is supplied from the R class tap extraction unit 103-2 using the representative signals Dr, Db and Dg of the R class tap that are supplied from the representative RGB calculate on unit 101.

G′=G−(Dg−Dr)

R′=R

B′=B−(Db−Dr) (6)

In Equation (6), G represents the low signals of the G pixels among the R class tap and the green image signals, and G′ represents the low signals of the G pixels and the green image signals after the G conversion process. R represents the low signals of the R pixels among the R class tap and the green image signals, and R′ represents the low signals of the R pixels and the green image signals after the G conversion process. B represents the low signals of the B pixels among the R class tap, and B′ represents the low signals of the B pixels after the G conversion process.

By carrying out this kind of R conversion process, the low signals of the G pixels and the B pixels within the R class tap offset the low signals of the R pixels as a standard. As a result of this configuration, it is possible to remove changes that are a result of differences in color between the pixels of the R class tap. As a result of this, it is possible to improve the correlation between pixels of the R class tap. The G conversion unit 105-3 supplies the R class tap after the R conversion process to the R class classification unit 106-2.

The R conversion unit 105-4 performs the same R conversion process as the R conversion process of the R conversion unit 105-3 with respect to the R predicted tap that is supplied from the R predicted tap extraction unit 104-2 using the representative signals Dr, Db and Dg of the R predicted tap that are supplied from the representative RGB calculation unit 101. The R conversion unit 105-4 supplies the R predicted tap after the R conversion process to the R product sum calculation unit 108-2.

The B conversion unit 105-5 performs a B conversion process according to the following Equation (7) with respect to the B class tap that is supplied from the B class tap extraction unit 103-3 using the representative signals Dr, Db and Dg of the B class tap that are supplied from the representative RGB calculation unit 101.

G′=G−(Dg−Db)

R′=R−(Dr−Db)

B′=B (7)

In Equation (7), G represents the low signals of the G pixels among the B class tap and the green image signals, and G′ represents the low signals of the G pixels and the green image signals after the G conversion process. R represents the low signals of the R pixels among the B class tap and the green image signals, and R′ represents the low signals of the R pixels and the green image signals after the G conversion process. B represents the low signals of the B pixels among the B class tap, and B′ represents the low signals of the B pixels after the G conversion process.

By carrying out this kind of B conversion process, the low signals of the G pixels and the R pixels within the B class tap offset the low signals of the B pixels as a standard. As a result of this configuration, it is possible to remove changes that are a result of differences in color between the pixels of the B class tap. As a result of this, it is possible to improve the correlation between pixels of the B class tap. The B conversion unit 105-5 supplies the B class tap after the B conversion process to the B class classification unit 106-3.

The B conversion unit 105-6 performs the same B conversion process as the B conversion process of the B conversion unit 105-5 with respect to the B predicted tap that is supplied from the B predicted tap extraction unit 104-3 using the representative signals Dr, Db and Dg of the B predicted tap that are supplied from the representative RGB calculation unit 101. The B conversion unit 105-6 supplies the B predicted tap after the B conversion process to the B product sum calculation unit 108-3.

The G class classification unit 106-1 performs an Adaptive Dynamic Range Coding process (ADRC) with respect to the G class tap that is supplied from the G conversion unit 105-1, and creates a re-quantization code. More specifically, as an ADRC process, the G class classification unit 106-1 performs a process according to the following Equation (8) that uniformly divides a gap between a maximum value MAX and a minimum value MTN of the G class tap into a designated number of bits p, and re-quantizes the result.

qi=[(ki−MIN+0.5)*2̂ p/DR] (8)

In Equation (8), [] indicates rounding down of numbers after the decimal point of a value within []. In addition, ki represents an i^{th} low signal of the G class tap, and qi represents a re-quantization code of the i^{th} low signal of the G class tap. In addition, DR is a dynamic range, and is MAX−MIN+1.

The G class classification unit 106-1 classifies the target pixel into a class on the basis of the re-quantization code. More specifically, according to the following Equation (9), the G class classification unit 106-1 computes a class code class that represents a class using the re-quantization code.

$$class = {\sum }_{i = 1}^{n} {qi ( {2}^{p} )}^{i - 1} \qquad ( 9 )$$

In Equation (9), n is a number of pixels that corresponds to the G class tap. The G class classification unit 106-1 supplies the class code to the G coefficient memory 107-1.

Additionally, as a method for computing the class code, in addition to a method that uses ADRC, it is possible to use a method that applies a data compression technique such as Discrete Cosine Transform (DCT), Vector Quantization (VQ), Differential Pulse Code Modulation (DPCM) or the like, and assigns a class code to a data quantity of a compressed result, or the like.

The R class classification unit 106-2 performs an ADRC process with respect to the R class tap that is supplied from the R conversion unit 105-3 in the same manner as the G class classification unit 106-1, and creates a re-quantization code. The R class classification unit 106-2 classifies the target pixel into a class on the basis of the re-quantization code in the same manner as the G class classification unit 106-1. The R class classification unit 106-2 supplies the class code that is obtained as a result of the abovementioned classification to the R coefficient memory 107-2.

The B class classification unit 106-3 performs an ADRC process with respect to the B class tap that is supplied from the B conversion unit 105-5 in the same manner as the G class classification unit 106-1, and creates a re-quantization code. The B class classification unit 106-3 classifies the target pixel into a class on the basis of the re-quantization code in the same manner as the G class classification unit 106-1. The B class classification unit 106-3 supplies the class code that is obtained as a result of the abovementioned classification to the B coefficient memory 107-3.

The G coefficient memory 107-1 stores a G predicted coefficient in association with the class code and the ddr_class_g. As will be described later, the G predicted coefficient is a predicted coefficient that is learned in advance, for each class code and ddr_class_g, by solving a normal equation that represents a relationship between a teacher signal, which corresponds to the green image signal, of each pixel, a student signal, which corresponds to the low signals, of pixels that correspond to the pixels, and a predicted coefficient using the teacher signal and the student signal.

The G coefficient memory 107-1 reads the G predicted coefficient, that is stored in association with the class code that is supplied from the G class classification unit 106-1 and the ddr_class_g that is supplied from the shape determination unit 102, and supplies the G predicted coefficient to the G product sum calculation unit 108-1.

The R coefficient memory 107-2 stores an R predicted coefficient in association with the class code. As will be described later, the R predicted coefficient is a predicted coefficient that is learned in advance, for each class code, by solving a normal equation that represents a relationship between a teacher signal, which corresponds to the red image signal, of each pixel, a student signal, which corresponds to the low signals, of pixels that correspond to the pixels, and a predicted coefficient using the teacher signal and the student signal. The R coefficient memory 107-2 reads the R predicted coefficient that is stored in association with the class code that is supplied from the R class classification unit 106-2, and supplies the R predicted coefficient to the R product sum calculation unit 108-2.

The B coefficient memory 107-3 stores a R predicted coefficient in association with the class code. As will be described later, the B predicted coefficient is a predicted coefficient that is learned in advance, for each class code, by solving a normal equation that represents a relationship between a teacher signal, which corresponds to the blue image signal, of each pixel, a student signal, which corresponds to the low signals, of pixels that correspond to the pixels, and a predicted coefficient using the teacher signal and the student signal. The B coefficient memory 107-3 reads the B predicted coefficient that is stored in association with the class code that is supplied from the B class classification unit 106-3, and supplies the B predicted coefficient to the B product sum calculation unit 108-3.

The G product sum calculation unit 108-1 creates the green image signal of the target pixel through predictive calculation of the G predicted coefficient that as read from the G coefficient memory 107-1 and the G predicted tap that is supplied from the G conversion unit 105-2. In addition to supplying the green image signal of the target pixel to the R class tap extraction unit 103-2, the B class tap extraction unit 103-3, the R predicted tap extraction unit 104-2 and the B predicted tap extraction unit 104-3, the G product sum calculation unit 108-1 outputs the green image signal of the target pixel.

The R product sum calculation unit 108-2 creates the red image signal of the target pixel through predictive calculation of the R predicted coefficient that is read from the R coefficient memory 107-2 and the R predicted tap that is supplied from the R conversion unit 105-4, and outputs the red image signal of the target pixel.

The B product sum calculation unit 108-3 creates the blue image signal of the target pixel through predictive calculation of the B predicted coefficient that is read from the B coefficient memory 107-3 and the B predicted tap that is supplied from the B conversion unit 105-6, and outputs the blue image signal of the target pixel.

In the abovementioned manner, the G class tap extraction unit 103-1, the G predicted tap extraction unit 104-1, the G conversion unit 105-1, the G conversion unit 105-2, the G class classification unit 106-1, the G coefficient memory 107-1 and the G product sum calculation unit 108-1 of the image processing apparatus 100 function as a green interpolation unit that creates green image signals using a class classification adaptive process.

In addition, the R class tap extraction unit 103-2, the R predicted tap extraction unit 104-2, the R conversion unit 105-3, the R conversion unit 105-4, the R class classification unit 106-2, the R coefficient memory 107-2 and the R product sum calculation unit 108-2 function as a red interpolation unit that creates red image signals using a class classification adaptive process. The B class tap extraction unit 103-3, the B predicted tap extraction unit 104-3, the B conversion unit 105-5, the B conversion unit 105-6, the B class classification unit 106-3, the B coefficient memory 107-3 and the B product sum calculation unit 108-3 function as a blue interpolation unit that creates blue image signals using a class classification adaptive process.

### Example of Tap Structures

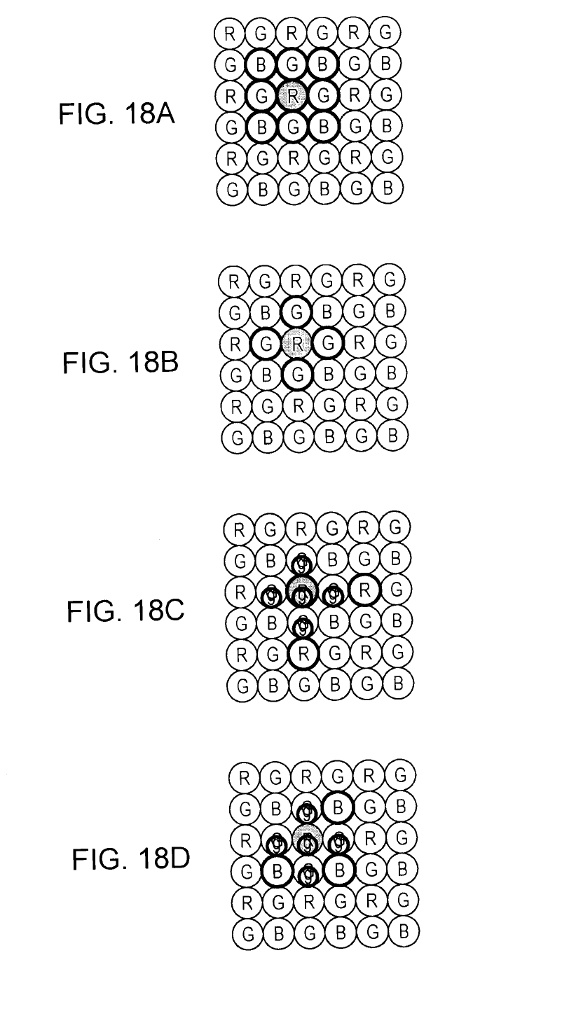

FIGS. 18A to 18D are views that show examples of tap structures of the G class tap, the R class tap, the B class tap, the G predicted tap, the R class tap and the G class tap.

Additionally, in FIGS. 18A to 18D, the circles to which an R has been added represent the low signals of R pixels, the circles to which a G has been added represent the low signals of G pixels, and the circles to which a B has been added represent the low signals of B pixels. In addition, the circles to which a g has been added represent the green image signals of pixels that correspond to pixels, which circles that include the abovementioned circles represent.

In the examples of FIGS. 18A to 18D, pixels that correspond to the low signals of R pixels that circles to which color has been added in the drawing represent, are set as target pixels. In this case, as shown in FIG. 18A, when the ddr_class_g is 0, the G class tap and the G predicted tap are configured by the low signals of a set 3×3 pixels with an R pixel that corresponds to the target pixel as the center thereof, which are represented by circles in the drawing to which a thick line has been added to the outer periphery thereof. That is, in a case in which the shape of the low signals is not a wedge shape, the G class tap and the G predicted tap are formed from the R pixels, the G pixels and the B pixels.

Meanwhile, as shown in FIG. 18B, when the ddr_class_g is 1, the G class tap and the G predicted tap are configured by the low signals of the four G pixels that are the closest pixels above, below, to the left and right of the R pixel that corresponds to the target pixel, which are represented by circles in the drawing to which a thick line has been added to the outer periphery thereof. That is, in a case in which the shape of the low signals is a wedge shape, the G class tap and the G predicted tap are formed from the G pixels only.

In addition, as shown in FIG. 18C, the R class tap and the R predicted tap include the low signals of the R pixel that corresponds to the target pixel and the R pixels that are the closest pixels to a right side and a lower side of the R pixel, which are represented by circles in the drawing to which a thick line has been added to the outer periphery thereof. In addition, the R class tap and the R predicted tap include the green image signals of the target pixel and the pixels that are adjacent above, below, to the left and right of the target pixel, which are represented by circles in the drawing to which a thick line has been added to the outer periphery thereof. That is, the R class tap and the R predicted tap are configured by the low signals of three R pixels, and the green image signals of five pixels.

In addition, as shown in FIG. 18D, the B class tap and the B predicted tap include the low signals of the B pixels that are the closest pixels to an upper right side, a lower right side and a lower left side of the R pixel that corresponds to the target pixel, which are represented by circles in the drawing to which a thick line has been added to the outer periphery thereof. In addition, the B class tap and the B predicted tap include the green image signals of the target pixel and the pixels that are adjacent above, below, to the left and right of the target pixel, which are represented by circles in the drawing to which a thick line has been added to the outer periphery thereof. That is, the B class tap and the B predicted tap are configured by the low signals of three B pixels, and the green image signals of five pixels.

Additionally, in the examples of FIGS. 18A to 18D, the target pixel is set as a pixel that corresponds to an R pixel, but, except for the matters indicated below, the same also applies to a case in which the target pixel is a pixel that corresponds to a G pixel.

In a case in which the target pixel is a pixel that corresponds to a G pixel, when the ddr_class_g is 1, the G class tap and the G predicted tap are, for example, configured by the low signals of the G pixel that corresponds to the target pixel, and the four G pixels that are the closest pixels above, below, to the left and light of the G pixel. In addition, in place of the low signals of the R pixel that corresponds to the target pixel and the R pixels that are the closest pixels to a right side and a lower side of the R pixel, the low signals of the R pixels that are the closest pixels to the G pixel that corresponds to the target pixel and the R pixels that are the closest pixels to a right side and a lower side of those R pixels are selected as the R class tap and the R predicted tap.

In addition, except for the matters indicated below, the same also applies to a case in which the target pixel is a pixel that corresponds to a B pixel.

In a case in which the target pixel is a pixel that corresponds to a B pixel, in place of the low signals of the R pixel that corresponds to the target pixel and the R pixels that are the closest pixels to a right side and a lower side of the R pixel, the low signals of the R pixels that are the closest pixels to the B pixel that corresponds to the target pixel and the R pixels that are the closest pixels to a right side and a lower side of those R pixels are selected as the R class tap and the R predicted tap.

In addition, in this instance, the G class tap, the G predicted tap, the R class tap, the R predicted tap, the B class tap and the B predicted tap are respectively set to have the same structure, but the structures thereof may differ.

### Description of Predictive Calculation

Next, the predictive calculation in the G product sum calculation unit 108-1 in FIG. 17 and the learning of the G predicted coefficient that is used in the predictive calculation will be described.

At the present time, if, for example, linear primary predictive calculation is adopted as the predictive calculation, a green image signal y of each pixel is derived using the following linear primary formula.

$$y = {\sum }_{i = 1}^{n} {W}_{i} {x}_{i} \qquad ( 10 )$$

In Equation (10), x₁ represents the low signal of an i^{th} pixel among the low signals that configure the G class tap of the image signal y, and Wᵢ represents an i^{th} G predicted coefficient that is multiplied by the low signal of the i^{th} pixel. In addition, n represents the number of pixels that correspond to the low signals that configure the G class tap. The same applies to Equations (11), (12), (14) and (17) below.

In addition, if yₖ′ is used to represent a predicted value of the green image signal y of each pixel of a k^{th} sample, the predicted value yₖ′ is represented by the following Equation (11).

yₖ′=W₁×xₖ₁+W₂×xₖ₂+ . . . +Wₙ×xₖₙ (11)

In Equation (11), xₖᵢ represents the low signal of an i^{th} pixel among the low signals that configure the G predicted tap of a true value of the predicted value yₖ′. The same applies to Equations (12), (15) and (16) which will be described later.

In addition, if yₖ is used to represent a true value of predicted value yₖ′, a predicted error eₖ is represented by the following Equation (12).

eₖ=yₖ−{W₁×xₖ₁+W₂×+xₖ₂+ . . . +Wₙn×xₖₙ} (12)

A G predicted coefficient Wᵢ that makes the predicted error eₖ of Equation (12) 0 is an optimum factor for predicting the true value yₖ, but in a case in which the number of samples for learning is smaller than n, the G predicted coefficient Wᵢ is not specified uniquely.

In such an instance, as a model that represents the fact that the G predicted coefficient Wᵢ is an optimum factor, for example, if it is set so that a least-squares technique is adopted, the optimum G predicted coefficient Wᵢ can be derives by setting a sum total E of square error that is represented by the following Equation (13) to a minimum.

$$E = {\sum }_{k = 1}^{m} {e}_{k}^{2} \qquad ( 13 )$$

As shown in the following Equation (14), a minimum value (a smallest value) of the sum total E of square error of Equation (13) can be given by Wᵢ that sets a factor in which the sum total E has been partially differentiated using the G predicted coefficient Wᵢ to 0.

$$\frac{\partial E}{\partial {W}_{i}} = {\sum }_{k = 1}^{m} 2 ( \frac{\partial {e}_{k}}{\partial {W}_{i}} ) {e}_{k} = {\sum }_{k = 1}^{m} 2 \times {k}_{i} \cdot {e}_{k} = 0 \qquad ( 14 )$$

As shown in Equation (15) and Equation (16) below, if Xᵢⱼ and Yᵢ are defined, Equation (14) can be represented in a determinant form in the manner of the following Equation (17).

$$\begin{matrix}{X}_{ij} = {\sum }_{k = 1}^{m} {x}_{ki} \times {x}_{kj} & ( 15 ) \\ {Y}_{i} = {\sum }_{k = 1}^{m} {x}_{ki} \times {y}_{k} & ( 16 ) \\ ( \begin{matrix}{X}_{11} & {X}_{12} & … & {X}_{1 n} \\ {X}_{21} & {X}_{22} & … & {X}_{2 n} \\ ⋮ & ⋮ & ⋮ & ⋮ \\ {X}_{n 1} & {X}_{n 2} & … & {X}_{nn}\end{matrix} ) ( \begin{matrix}{W}_{1} \\ {W}_{2} \\ ⋮ \\ {W}_{n}\end{matrix} ) = ( \begin{matrix}{Y}_{1} \\ {Y}_{2} \\ ⋮ \\ {Y}_{n}\end{matrix} ) & ( 17 )\end{matrix}$$

The normal equation of Equation (17) can, for example, be solved for the G predicted coefficient Wᵢ by using a general matrix solution technique such as a discharge calculation technique (the Gauss-Jordan elimination technique).

According to the abovementioned configuration, the learning of the optimum G predicted coefficient Wᵢ for each class code and ddr_class_g can be performed by solving the normal equation of Equation (17) for each class code and ddr_class_g.

Additionally, in place of the linear primary formula that is shown in Equation (10), the image signal y can be set to be derived using a higher order formula of secondary or more.

Since, except for the fact that the G predicted tap is substituted for the R predicted tap or the B predicted tap, and the fact that the G predicted coefficient for each class code and ddr_class_g is substituted for the R predicted coefficient or the B predicted coefficient for each class code, the predictive calculations in the R product sum calculation unit 108-2 and the B product sum calculation unit 108-3 are the same as the predictive calculation in the G product sum calculation unit 108-1, description thereof has been omitted.

### Description of Processes of Image Processing Apparatus

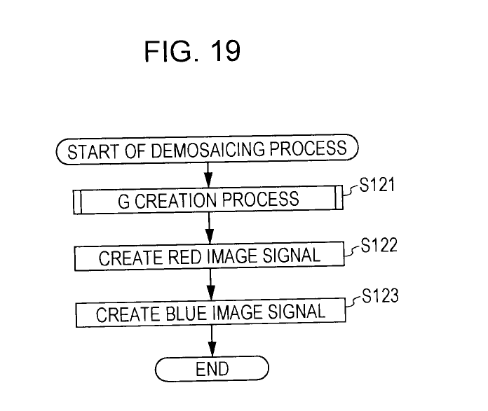

FIG. 19 is a flowchart that describes a demosaicing process of the image processing apparatus 100 in FIG. 17. The demosaicing process is, for example, initiated when low signals, which are captured by the single panel image sensor that is not shown in the drawings, are input into the image processing apparatus 100.

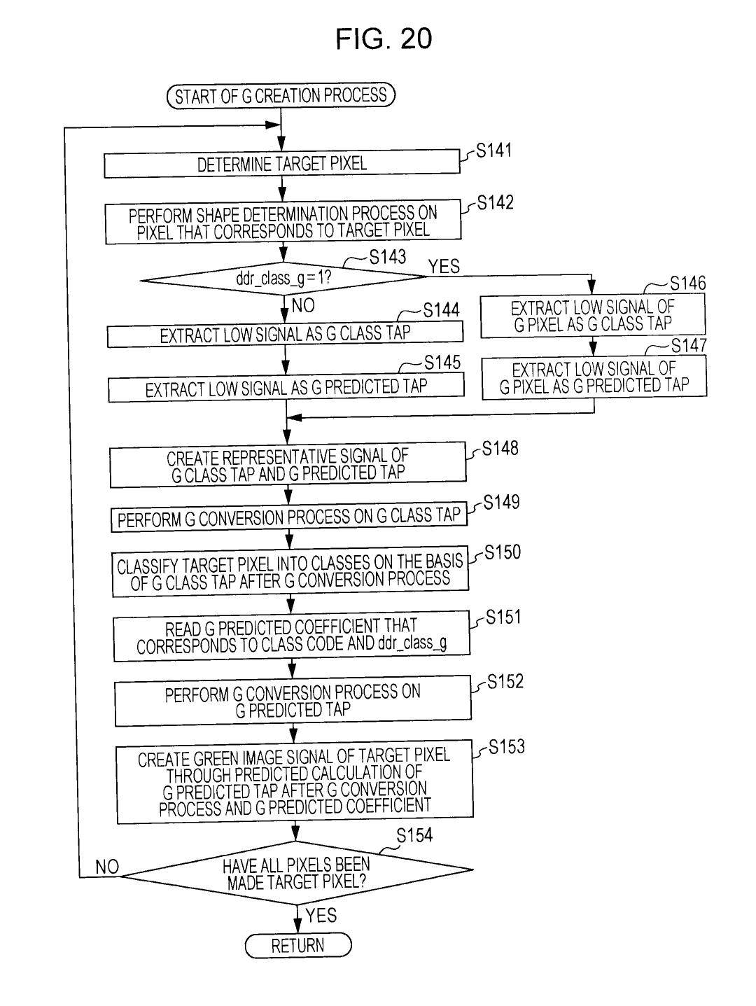

In Step S121 in FIG. 19, the image processing apparatus 100 performs a G creation process that creates the green image signals front the input low signals. The details of the G creation process will be described with reference to FIG. 20 which will be described later.

In Step S122, the image processing apparatus 100 creates the red image signals using a class classification adaptive process on the basis of the green image signals that are created by the G creation process and the low signals. That is, the representative RGB calculation unit 101, the R class tap extraction unit 103-2, the R predicted tap extraction unit 104-2, the R conversion unit 105-3, the R conversion unit 105-4, the R class classification unit 106-2, the R coefficient memory 107-2 and the R product sum calculation unit 108-2 of the image processing apparatus 100 create the red image signals by performing a class classification adaptive process.

In Steps S123, the image processing apparatus 100 creates the blue image signals using a class classification adaptive process on the basis of the green image signals that are created by the G creation, process and the low signals. That is, the representative RGB calculation unit 101, the B class tap extraction unit 103-3, the B predicted tap extraction unit 104-3, the B conversion unit 105-5, the B conversion unit 105-6, the B class classification unit 106-3, the B coefficient memory 107-3 and the B product sum calculation unit 108-3 of the image processing apparatus 100 create the blue image signals by performing a class classification adaptive process. Further, the process ends.

FIG. 20 is a flowchart that describes a G creation process of Step S121 in FIG. 19 in detail.

In Step S141 in FIG. 20, among each pixel of an image that corresponds to an image signal that is created by a demosaicing process, the representative RGB calculation unit 101 of the image processing apparatus 100 determines a pixel that has not yet been determined as the target pixel as the target pixel.

In Step S142, the shape determination unit 102 performs a shape determination process with respect to a pixel that corresponds to the target pixel. The shape determination unit 102 supplies a ddr_class_g that represents a determination result to the G class tap extraction unit 103-1, the G predicted tap extraction unit 104-1 and the G coefficient memory 107-1.

In Step S143, the G class tap extraction unit 103-1 determines whether or not the ddr_class_g that is supplied from the shape determination unit 102 is 1. In a case in which it is determined in Step S143 that the ddr_class_g is not 1, the process proceeds to Step S144.

In Step S144, the G class tap extraction unit 103-1 extracts the low signals of a set of 3×3 pixels with a pixel that corresponds to the target pixel as the center thereof from the input low signals as the G class tap, and supplies the G class tap to the G conversion unit 105-1. In Step S145, the G predicted tap extraction unit 104-1 extracts the same low signals as the G class tap from the input low signals as the G predicted tap, and supplies the G predicted tap to the G conversion unit 105-2. Further, the process proceeds to Step S148.

Meanwhile, in a case in which it is determined in step S143 that the ddr_class_g is 1, the process proceeds to Step S146.

In Step S146, the G class tap extraction unit 103-1 extracts the low signals of the four G pixels that are the closest pixels above, below, to the left and right of a pixel that corresponds to the target pixel as the G class tap. Additionally, in a case in which a pixel that corresponds to the target pixel is a G pixel, for example, the G class tap extraction unit 103-1 extracts the low signals of the G pixel that corresponds to the target pixel, and the four G pixels that are the closest pixels above, below, to the left and right of the G pixel as the G class tap. The G class tap extraction unit 103-1 supplies the G class tap to the G conversion unit 105-1.

In Step S147, the G predicted tap extraction unit 104-1 extracts the low signals of the same G pixels as the G class tap from the input low signals as the G predicted tap, and supplies the G predicted tap to the G conversion unit 105-2. Further, the process proceeds to Step S148.

In Step S148, the representative RGB calculation unit 101 calculates representative signals Dr, Db and Dg of the G class tap and the G predicted tap on the basis of the input low signals. The representative RGB calculation unit 101 supplies the representative signals Dr, Db and Dg of the G class tap to the G conversion unit 105-1, and supplies the representative signals Dr, Db and Dg of the G predicted tap to the G conversion unit 105-2.

In Step S149, the G conversion unit 105-1 performs a G conversion process with respect to the G class tap that is supplied from the G class tap extraction unit 103-1 using the representative signals Dr, Db and Dg of the G class tap that are supplied from the representative RGB calculation unit 101. The G conversion unit 105-1 supplies the G class tap after the G conversion process to the G class classification unit 106-1.

In Step S150, the G class classification unit 106-1 classifies the target pixel into a class on the basis of the G class tap after the G conversion process that is supplied from the G conversion unit 105-1. The G class classification unit 106-1 supplies a class code that is obtained as a result of the abovementioned process to the G coefficient memory 107-1.

In Step S151, the G coefficient memory 107-1 reads a G predicted coefficient that corresponds to the class code that is supplied from the G class classification unit 106-1 and the ddr_class_g that is supplied from the shape determination unit 102, and supplies the G predicted coefficient to the G product sum calculation unit 108-1.

In Step S152, the G conversion unit 105-2 performs a G conversion process with respect to the G predicted tap that is supplied from the G predicted tap extraction unit 104-1 using the representative signals Dr, Db and Dg of the G predicted tap that are supplied from the representative RGB calculation unit 101. The G conversion unit 105-2 supplies the G predicted tap after the G conversion process to the G product sum calculation unit 108-1.

In Step S153, the G product sum calculation unit 108-1 creates the green image signal of the target pixel through predictive calculation of the G predicted tap after the G conversion process that is supplied from the G conversion unit 105-2 and the G predicted coefficient that is read from the G coefficient memory 107-1. In addition to supplying the green image signal of the target pixel to the R class tap extraction unit 103-2, the B class tap extraction unit 103-3, the R predicted tap extraction unit 104-2 and the B predicted tap extraction unit 104-3, the G product sum calculation unit 108-1 outputs the green image signal of the target pixel.

In Step S154, the representative RGB calculation unit 101 determines whether or not all of the pixels of an image that corresponds to the image signal have been set as the target pixel. In a case in which it is determined in Step S154 that all of the pixels have not been set as the target pixel, the process returns to Step S141, and the processes of Step S141 to Step S154 are repeated until all of the pixels are set as the target pixel.

Meanwhile, in a case in which it is determined in Step S154 that all of the pixels were set as the target pixel, the process returns to Step S121 in FIG. 19, and proceeds to Step S122.

In the abovementioned manner, in the image processing apparatus 100, the G class tap is configured using only the low signals of G pixels in a case in which the shape of the low signals is a wedge shape in which there is a tendency for zippier noise to be generated by a demosaicing process that uses a DLMMSE technique. Therefore, in this case, green image signals are created using only the low signals of G pixels. Accordingly, it is possible to reduce the image quality deterioration that is referred to as zipper noise in the image signal.

In addition, in a case in which the shape of the low signals of a pixel that corresponds to the target pixel is not a wedge shape, the image processing apparatus 100 creates green image signals using a G class tap that includes pixels other than G pixels. Therefore, it is possible to improve the resolution of the image signal in comparison with a case in which the green image signals of all pixels are created using only the low signals of G pixels.

### Configuration Example of Learning Device

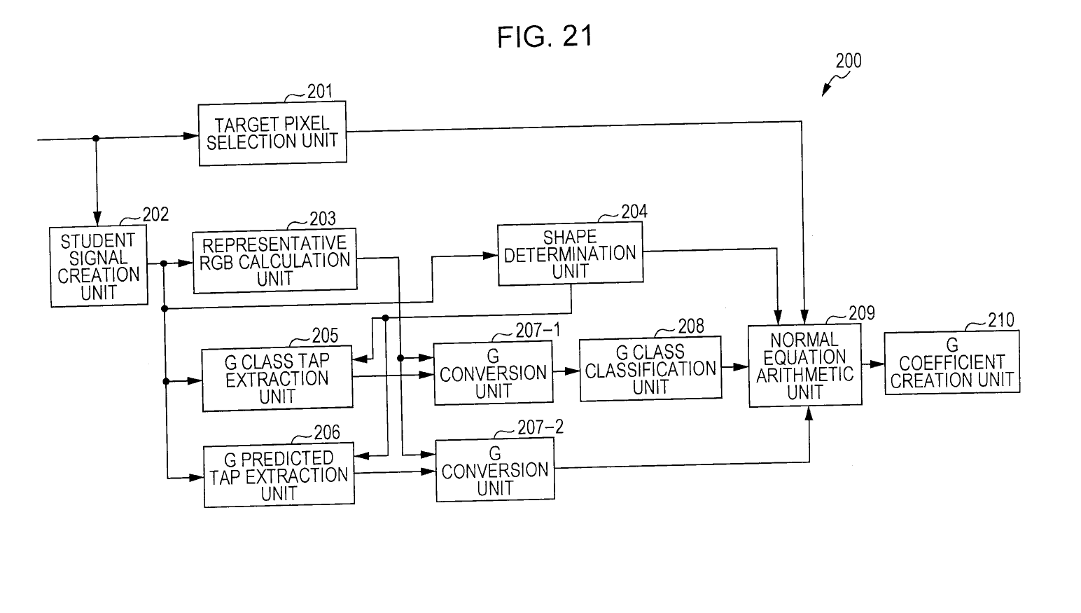

FIG. 21 is a block diagram that shows a configuration example of a learning device 200 that learns a G predicted coefficient that is stored in the G coefficient memory 107-1 in FIG. 17.

The learning device 200 in FIG. 21 is configured by a target pixel selection unit 201, a student signal creation unit 202, a representative RGB calculation unit 203, a shape determination unit 204, a G class tap extraction unit 205, a G predicted tap extraction unit 206, a G conversion unit 207-1, a G conversion unit 207-2, a G class classification unit 208, a normal equation arithmetic unit 209 and a G predicted coefficient creation unit 210.

A plurality of clear, green image signals without blur of an image for learning are input to the learning device 200 as teacher signals that are used in the learning of G predicted coefficients.

The target pixel selection unit 201 of the learning device 200 sets each pixel of an image that corresponds to each teacher signal as a target pixel in order. The target pixel selection unit 201 extracts a teacher signal of the target pixel from the input teacher signals, and supplies the teacher signal to the normal equation arithmetic unit 209.

The student signal creation unit 202 creates blurry low signals from the teacher signal by using a simulation model of an optical low pass filter or the like, and sets the low signals as student signals. The student signal creation unit 202 supplies the student signals to the representative RGB calculation unit 203, the shape determination unit 204, the G class tap extraction unit 205 and the G predicted tap extraction unit 206.

The representative RGB calculation unit 203 computes the representative signals Dg, Dr and Db of the G class tap and the G predicted tap in the same manner as a case of the representative RGB calculation unit 101 in FIG. 17 on the basis of the student signals that are supplied from the student signal creation unit 202. The representative RGB calculation unit 203 supplies the representative signals Dg, Dr and Db of the G class tap to the G conversion unit 207-1. In addition, the representative RGB calculation unit 203 supplies the representative signals Dg, Dr and Db of the G predicted tap to the G conversion unit 207-2.

The shape determination unit 204 determines, in the same manner as the shape determination unit 102, whether or not the shape of the student signals of a pixel that corresponds to the target pixel is a wedge shape on the basis of the student signals that sire supplied from the student signal creation unit 202. The shape determination unit 204 supplies the ddr_class_g, which represents the determination result to the G class tap extraction unit 205, the G predicted tap extraction unit 206 and the normal equation arithmetic unit 209.

The G class tap extraction unit 205 extracts the G class tap from the student signals that are supplied from the student signal creation unit 202 in the same manner as the G class tap extraction unit 103-1 on the basis of the ddr_class_g that is supplied from the shape determination unit 204, and supplies the G class tap to the G conversion unit 207-1.

The G predicted tap extraction unit 206 extracts the G predicted tap from the student signals that are supplied from the student signal creation unit 202 in the same manner as the G predicted tap extraction unit 104-1 on the basis of the ddr_class_g that is supplied from the shape determination unit 204, and supplies the G predicted tap to the G conversion unit 207-2.

The G conversion unit 207-1 performs a G conversion process in the same manner as the G conversion unit 105-1 with respect to the G class tap that is supplied from the G class tap extraction unit 205 using the representative signals Dr, Db and Dg of the G class tap that are supplied from the representative RGB calculation unit 203. The G conversion unit 207-1 supplies the G class tap after the G conversion process to the G class classification unit 208.

The G conversion unit 207-2 performs a G conversion process in the same manner as the G conversion unit 105-2 with respect to the G predicted tap that is supplied from the G predicted tap extraction unit 206 using the representative signals Dr, Db and Dg of the G predicted tap that are supplied from the representative RGB calculation unit 203. The G conversion unit 207-2 supplies the G predicted tap after the G conversion process to the normal equation arithmetic unit 209.

The G class classification unit 208 classifies the target pixel into a class in the same manner as the G class classification unit 106-1 on the basis of the G class tap that is supplied from the G conversion unit 207-1. The G class classification unit 208 supplies a class code that is obtained as a result of the abovementioned process to the normal equation arithmetic unit 209.

The normal equation arithmetic unit 209 performs addition that has the teacher signal of the target pixel from the target pixel selection unit 201 and the G predicted tap from the G conversion unit 207-2 as the target thereof for the class code from the G class classification unit 208 and the ddr_class_g from the shape determination unit 204 (a combination thereof).

More specifically, the normal equation arithmetic unit 209 sets the student signals of each pixel of the G predicted tap as xₖᵢ and xₖⱼ (i, j=1, 2, . . . , n) for the class code and the ddr_class_g of the target pixel, calculates xₖᵢ×xₖⱼ in a matrix of the left side of Equation (10), and adds up the result.

In addition, the normal equation arithmetic unit 209 sets the teacher signal of a target pixel as yₖ for the class code and the ddr_class_g of the target pixel, sets the student signal as xₖᵢ, calculates xₖᵢ×yₖ in a matrix of the right side of Equation (10), and adds up the result.

Further, the normal equation arithmetic unit 209 supplies a normal equation of Equation (10) for each class code and ddr_class_g, which has been created by setting all of the pixels of all of the teacher signals as the target pixel and adding up the results, to the G predicted coefficient creation unit 210.

The G predicted coefficient creation unit 210 derives an optimum G predicted coefficient for each class code and ddr_class_g by solving the normal equations that are supplied from the normal equation arithmetic unit 209. The G predicted coefficients for each class code and ddr_class_g are stored in the G coefficient memory 107-1 in FIG. 17.

### Description of Processes of Learning Device

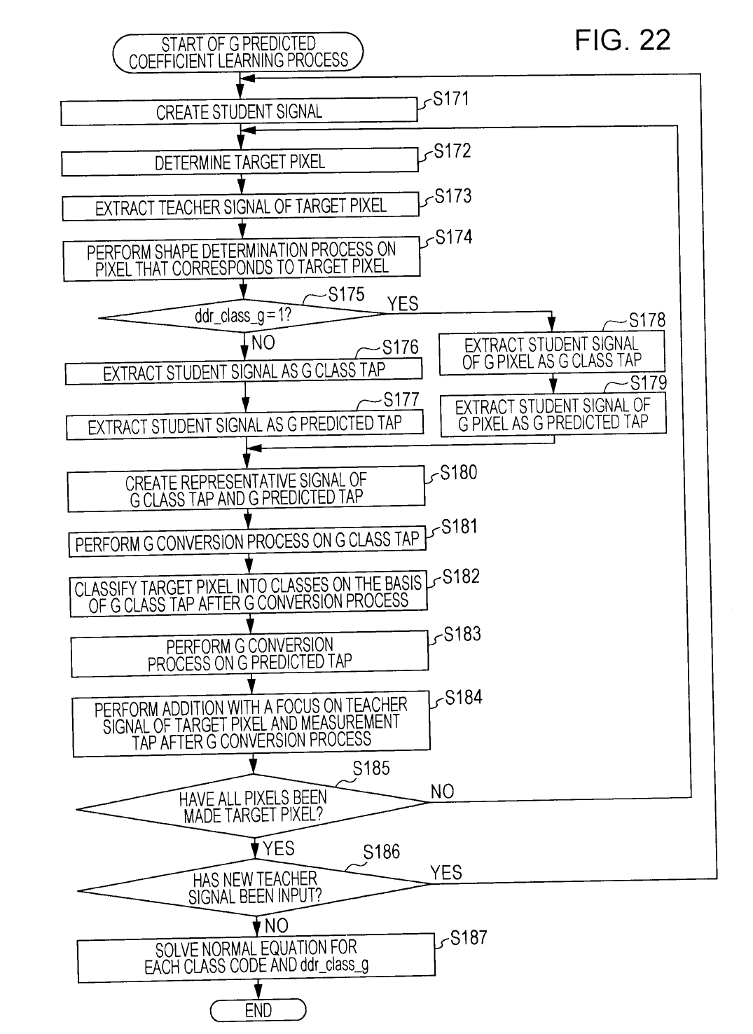

FIG. 22 is a flowchart that describes a G predicted coefficient learning process of the learning device 200 in FIG. 21. The G predicted coefficient learning process is, for example, initiated when teacher signals are input into the learning device 200.

In Step S171 in FIG. 22, the student signal creation unit 202 of the learning device 200 creates blurry low signals from an input teacher signal by using a simulation model of an optical low pass filter or the like, and sets the low signals as student signals. The student signal creation unit 202 supplies the student signals to the representative RGB calculation unit 203, the shape determination unit 204, the G class tap extraction unit 205 and the G predicted tap extraction unit 206.

In Step S172, among the green image signals of an image that corresponds to the low signals that corresponds to the teacher signal, the target pixel selection unit 201 determines a pixel that has not yet been set as the target pixel as the target pixel. In Step S173, the target pixel selection unit 201 extracts a teacher signal of the target pixel from the input teacher signals, and supplies the teacher signal to the normal equation arithmetic unit 209.

In step S174, the shape determination unit 204 performs a shape determination process with respect to a pixel that corresponds to the target pixel on the basis of the student signals that are supplied from the student signal creation unit 202. The shape determination unit 204 supplies the ddr_class_g that is obtained as a result of the abovementioned process to the G class tap extraction unit 205, the G predicted tap extraction unit 206 and the normal equation arithmetic unit 209.

In Step S175, the G class tap extraction unit 205 determines whether or not the ddr_class_g that is supplied from the shape determination unit 204 is 1. In a case in which it is determined in Step S175 that the ddr_class_g is not 1, the process proceeds to Step S176.

In Step S176, G class tap extraction unit 205 extracts the student signals of a set of 3×3 pixels with a pixel that corresponds to the target pixel as the center thereof from the student signal that are supplied from the student signal creation unit 202 as the G class tap, and supplies the G class tap to the G conversion unit 207-1.

In Step S177, the G predicted tap extraction unit 206 extracts the same student signals as the G class tap from the student signals that are supplied from the student signal creation unit 202 as the G predicted tap, and supplies the G predicted tap to the G conversion unit 207-2. Further, the process proceeds to Step S180.

Meanwhile, in a case in which it is determined in Step S175 that the ddr_class_g is 1, the process proceeds to Step S178.

In Step S178, the G class tap extraction unit 205 extracts the student signals of the four G pixels that are the closest pixels above, below, to the left and right of a pixel that corresponds to the target pixel from the student signals that are supplied from the student signal creation unit 202 as the G class tap. Additionally, in a case in which a pixel that corresponds to the target pixel is a G pixel, for example, the G class tap extraction unit 205 extracts the student signals of the G pixel that corresponds to the target pixel, and the four G pixels that are the closest pixels above, below, to the left and right of the G pixel as the G class tap. The G class tap extraction unit 205 supplies the G class tap to the G conversion unit 207-1.

In Step S179, the G predicted tap extraction unit 206 extracts the student signals of the same G pixels as the G class tap from the student signals that are supplied from the student signal creation unit 202 as the G predicted tap, and supplies the G predicted tap to the G conversion unit 207-2. Further, the process proceeds to Step S180.

In Step S180, the representative RGB calculation unit 203 computes representative signals Dg, Dr and Db of the G class tap and the G predicted tap on the basis of the student signals that are input from the student signal creation unit 202. The representative RGB calculation unit 203 supplies the representative signals Dg, Dr and Db of the G class tap to the G conversion unit 207-1. In addition, the representative RGB calculation unit 203 supplies the representative signals Dg, Dr and Db of the G predicted tap to the G conversion unit 207-2.

In Step S181, G conversion unit 207-1 performs a G conversion process with respect to the G class tap that is supplied from the G class tap extraction unit 205 using the representative signals Dr, Db and Dg of the G class tap that are supplied from representative RGB calculation unit 203. The G conversion unit 207-1 supplies the G class tap after the G conversion process to the G class classification unit 208.

In Step S182, the g class classification unit 208 classifies the target pixel into a class on the basis of the G class tap after the G conversion process that is supplied from the G conversion unit 207-1. The G class classification unit 208 supplies a class code that is obtained as a result of the abovementioned process to the normal equation arithmetic unit 209.

In Step S183, the G conversion unit 207-2 performs a G conversion process with respect to the G predicted tap that is supplied from the G predicted tap extraction unit 206 using the representative signals Dr, Db and Dg of the G predicted tap that are supplied from representative RGB calculation unit 203. The G conversion unit 207-2 supplies the G predicted tap after the G conversion process to the normal equation arithmetic unit 209.

In Step S184, the normal equation arithmetic unit 209 performs addition that has the teacher signal of the target pixel and the G predicted tap after the G conversion process as the target thereof for the class code from the G class classification unit 200 and the ddr_class_g from the shape determination unit 204.

In Step S185, the target pixel selection unit 201 determines whether or not all of the pixels of an image that corresponds to the teacher signal have been set as the target pixel. In a case in which it is determined in Step S185 that all of the pixels leave not been set as the target pixel, the process returns to Step S172, and the processes of Step S172 to Step S185 are repeated until all of the pixels are set as the target pixel.

Meanwhile, in a case in which it is determined in Step S185 that all of the pixels were set as the target pixel, in Step S186, the student signal creation unit 202 determines whether or not a new teacher signal has been input. In a case in which it is determined in Step S186 that a new teacher signal has been input, the process returns to Step S171, and the processes of Step S171 to Step S186 are repeated until new teacher signals are no longer input.

In a case in which it is determined in Step S186 that a new teacher signal has not been input, the normal equation arithmetic unit 209 supplies a normal equation of Equation (10) for each class code and ddr_class_g, which has been created by setting all of the pixels of all of the teacher signals as the target pixel and adding up the results, to the G predicted coefficient creation unit 210.

Further, in Step S187, the G predicted coefficient creation unit 210 derives an optimum G predicted coefficient for each class code and ddr_class_g by solving the normal equations for each class code and the ddr_class_g that is supplied from the normal equation arithmetic unit 209. The G predicted coefficients for each class code and ddr_class_g are stored in the G coefficient memory 107-1 in FIG. 17.

In the abovementioned manner, the learning device 200 sets clear, green image signals without blur as teacher signals, sets blurry low signals as student signals, and creates the G predicted coefficient. Therefore, the image processing apparatus 100 that creates a green image signal using this G predicted coefficient can creates clear green image signal without blur.

Additionally, description has been omitted, but except for the fact that the structures of the class tap and the predicted tap do not change on the basis of the ddr_class_g, and the fact that the predicted coefficient is derived by the normal equation being created for each class code, the learning device and the learning process that learn the R predicted coefficient and the B predicted coefficient are the same as the learning device 200 in FIG. 21 and the learning process in FIG. 22.

In addition, in the second embodiment, in a case in which the ddr_class_g is 1, the structure of the G class tap and the G predicted tap was determined regardless of hv, but a configuration in which the structure of the G class tap and the G predicted tap change depending on hv may be used. In this case, for example, in a case in which hv is 1, the G class tap and the G predicted tap are set to the low signals of the two G pixels that are the closest pixels above and below a pixel that corresponds to the target pixel. Meanwhile, in a case in which hv is 0, the G class tap and the G predicted tap are set to the low signals of the two G pixels that are the closest pixels to the left and right of a pixel that corresponds to the target pixel.

### Application in Another Pixel Array

### Example of Another Pixel Array

FIG. 23 is a view that shows another example of a pixel array of the single panel image sensor that is not shown in the drawings that generates the low signals.

As shown in FIG. 23, the pixel array of the single panel image sensor that is not shown in the drawings that generates the low signals can be set to a double Bayer array (an inclined Bayer array).

In this case, when converting from the low signals to an image signal that has twice the resolution of the low signals, in the same manner as a case in which the pixel array that corresponds to the low signals is a Bayer array, there is a tendency for zippier noise to be generated in lines in the H direct ion and the V direction when the shape of the low signals is a wedge shape. Therefore, in this case, it is also possible to reduce zipper noise in the image signal by inputting the low signals to the image processing apparatus 10 and the image processing apparatus 100, and performing a demosaicing process.

However, in processes other than the shape determination process, the H direction and the V direction are substituted for directions in which the H direction and the V direction have been rotated by −45°. In addition, the shape determination process is substituted for the following shape determination process in FIG. 24. In this shape determination process, a set of 3×3 pixels of G pixels g20 to g28 in the periphery of a pixel 230, which corresponds to a green image signal that is created, are set as a shape determination pixel group for the pixel 230.

### Description of Shape Determination Process

FIG. 24 is a flowchart that describes a shape determination process of the shape determination unit 11 in a case in which a pixel array of the single panel image sensor that is not shown in the drawings that creates the low signals is the double Bayer array in FIG. 23.

In Step S201 in FIG. 24, the shape determination unit 11 computes a dynamic range LocalGDR of the low signals of the G pixels of a shape determination pixel group on the basis of the low signals that are input from the single panel image sensor that is not shown in the drawings. For example, in a case in which the shape determination pixel group is the G pixels g20 to g28 in FIG. 10, the shape determination unit 11 detects a maximum value and a minimum value of the low signals of the G pixels g20 to g28, and computes a subtracted value in which the minimum value has been subtracted from the maximum value as the dynamic range LocalGDR.

In Step S202, the shape determination unit 11 computes a dynamic range h_ddr of the low signals of the central horizontal line and a dynamic range v_ddr of the low signals of the central vertical line of the shape determination pixel group. More specifically, the shape determination unit 11 computes a subtracted value in which the minimum value of the low signals of the G pixels g23 to g25 has been subtracted from the maximum value thereof, and sets the value as a dynamic range h_ddr. In addition, the shape determination unit 11 computes a subtracted value in which the minimum value of the low signals of the G pixels g21, g24 and g27 has been subtracted from the maximum value thereof, and sets the value as a dynamic range v_ddr.

In Step S203, the shape determination unit 11 computes an average value of the low signals of each horizontal line and each vertical line. More specifically, the shape determination unit 11 computes an average value have0 of the low signals of the G pixels g20 to g22, computes an average value have1 of the low signals of the G pixels g23 to g25, and computes an average value have2 of the low signals of the G pixels g26 to g28.

In additive, the shape determination unit 11 computes an average value vave0 of the low signals of the G pixels g20, g23 and g26, computes an average value vave1 of the low signals of the G pixels g21, g24 and g27, and computes an average value vave2 of the low signals of the G pixels g22, g25 and g28.

In Step S204, the shape determination unit 11 determines whether or not dynamic range h_ddr is less than or equal to the dynamic range v_ddr. In a case in which it is determined in Step S204 that the dynamic range h_ddr is less than or equal to the dynamic range v_ddr, the process proceeds to Step S205.

In Step S205, the shape determination unit 11 sets the dynamic range h_ddr as DDrMin. In Step S206, the shape-determination unit 11 determines a DDrFlag on the basis of the average values have0 to have2 of the low signals of the horizontal lines.

More specifically, in a case in which a value, in which an offset offset has been subtracted from the average value have2, is greater than the average value have1, and the average value have1 is greater than the average value have0, the shape determination unit 11 determines the DDrFlag as 0. In addition, in a case in which the average value have0 is greater than the average value have1, and the average value have1 is greater than a value, in which the average value have2 and the offset offset have been added, the shape determination unit 11 determines the DDrFlag as 0. Additionally, the offset offset is defined by the following Equation (18).

offset=abs(have2−habe0)/para (18)

In Equation (18), para is a parameter that is set in advance and, for example, can be set to 4. Meanwhile, in cases other than the abovementioned cases, the shape determination unit 11 determines the DDr_Flag as 1.

In Step S207, the shape determination unit 11 sets hv, which represents a direction of the determined wedge shape, to 0, which represents the V direction. hv is used by the G interpolation unit 12 when extracting the low signals in Step S15 in FIG. 8.

In the abovementioned manner, in a case in which the pixel array is a double Bayer array, in processes other than the shape determination process, the H direction and V direction are substituted for directions in which the H direction and the V direction have been rotated by −45°. Therefore, in a case in which hv is 0, in Step S15, the low signals of the two pixels that are the closest pixels to a pixel that corresponds to the G interpolation pixel in a direction in which the H direction has been rotated by −45° are extracted. For example, in a case in which the G interpolation pixel is the pixel 230 in FIG. 23, the low signals of the pixel g20 and the pixel g28 that are the closest pixels to a pixel g24 that is the closest pixel to a position of the pixel 230 in a direction in which the H direction has been rotated by −45° are extracted. After the process of Step S207, the process proceeds to Step S211.

Meanwhile, in a case in which it is determined in Step S204 that the dynamic range h_ddr is not less than or equal to dynamic range v_ddr, the process proceeds to Step 208.

In Step S208, the shape determination unit 11 sets the dynamic range v_ddr as DDrMin. In Step S209, the shape determination unit 11 determines a DDrFlag on the basis of the average values vave0 to vave2 of the low signals of the vertical lines.

More specifically, in a case in which a value, in which an offset offset, which is defined by Equation (18), has been subtracted from the average value vave2, is greater than the average value vave1, and the average value vave1 is greater than the average value vave0, the shape determination unit 11 determines the DDrFlag as 0. In addition, in a case in which the average value vave0 is greater than the average value vave1, and the average value vave1 is greater than a value, in which the average value vave2 and the offset offset, which is defined by Equation (18), have been added, the shape determination unit 11 determines the DDrFlag as 0. Meanwhile, in cases other than the abovementioned cases, the shape determination unit 11 determines the DDrFlag as 1.

In Step S210, the shape determination unit 11 sets hv to 1, which represents the H direction. hv is used by the G interpolation unit 12 when extracting the low signals in Step S15. As a result of this configuration, in Step S15, the low signals of the two pixels that are the closest pixels to a pixel that corresponds to the G interpolation pixel in a direction in which the V direction has been rotated by −45° are extracted. For example, in a case in which the G interpolation pixel is the pixel 230 in FIG. 23, the low signals of the pixel g22 and the pixel g26 that are the closest pixels to a pixel g24 that is the closest pixel to a position of the pixel 230 in a direction in which the V direction has been rotated by −45° are extracted. After the process of Step S210, the process proceeds to Step S211.

In Step S211, the shape determination unit 11 determines whether or not the DDrFlag is 1. In a case in which it is determined in Step S211 that the DDrFlag is 1, the process proceeds to Step S212. In Step S212, the shape determination unit 11 performs the same gray_mode computation process as Step S39 in FIG. 9.

In Step S213, the shape determination unit 11 determines whether or not the gray_mode that was computed by the gray_mode computation process is 0. In a case in which it is determined in Step S213 that the gray_mode is 0, in Step S214, the shape determination unit 11 determines whether or not DDrMin is less than or equal to k0 of the dynamic range LocalGDR.

In a case in which it is determined in Step S211 that DDrMin is less than or equal to k0 of the dynamic range LocalGDR, the process proceeds to Step S215. In Step S215, the shape determination unit 11 determines whether or not DDrMin is smaller than k4. In a case in which it is determined in Step S215 that DDrMin is smaller than k4, the process proceeds to Step S216.

In Step S216, the shape determination unit 11 sets the ddr_class_g as 1, and supplies the ddr_class_g to the G interpolation unit 12 and the selection unit 14. Further, the shape determination process ends.

Meanwhile, in a case in which it is determined in Step S211 that DDrFlag is not 1, a case in which it is determined in Step S214 that DDrMin is not less than or equal to k0 of the dynamic range LocalGDR, or a case in which it is determined in Step S215 that DDrMin is not smaller than k4, the process proceeds to Step S217.

In Step S217, the shape determination unit 11 sets the ddr_class_g to 0, and supplies the ddr_class_g to the G interpolation unit 12 and the selection unit 14. Further, the shape determination process ends.

In addition, in a case in which it is determined in Step S213 that the gray_mode is not 0, the process proceeds to Step S218. In Step S218, the shape determination unit 11 determines whether or not DDrMin is less than or equal to k2 of the dynamic range LocalGDR.

In a case in which it is determined in Step S218 that DDrMin is less than or equal to k2 of the dynamic range LocalGDR, the process proceeds to Step S219. In Step S219, the shape determination unit 11 determines whether or not DDrMin is smaller than k3. In a case in which it is determined in Step S219 that DDrMin is smaller than k3, the process proceeds to Step S216, and the abovementioned processes is performed.

Meanwhile, in a case in which it is determined in Step S218 that DDrMin is not less than or equal to k2 of the dynamic range LocalGDR, or a case in which it is determined in Step S219 that DDrMin is not smaller than k3, the process proceeds to Step S220.

In Step S220, the shape determination unit 11 sets the ddr_class_g to 0, and supplies the ddr_class_g to the G interpolation unit 12 and the selection unit 14. Further, the shape determination process ends

In the abovementioned manner, in a case in which the pixel array is a double Bayer array, the shape determination unit 11 performs the shape determination process on the basis of the low signals of the G pixels.

### Third Embodiment

### Inscription of Computer to which Present Disclosure has been Applied

The abovementioned series of processes may be executed using hardware or may be executed using software. In a case in which the series of processes is executed using software, a program that configures the software is installed on a computer. In this instance, as a computer, it is possible to include a computer that is included in dedicated hardware, a general use personal computer or the like that is capable of executing various functions due to various programs being installed thereon, for example.

FIG. 2b is a block diagram that shows a configuration example of the hardware of a computer that executes the abovementioned series of processes using a program.

In a computer 400, a Central Processing Unit (CPU) 401, a Read Only Memory (ROM) 402, and a Random Access Memory (RAM) 403 are mutually connected by a bus 404.

An input/output interface 405 is further connected to the bus 404. An input unit 406, an output unit 407, a storage unit 408, a communication unit 409 and a drive 410 are connected to the input/output interface 405.

The input unit 406 is formed from a keyboard, a mouse, a microphone or the like. The output unit 407 is formed from a display, a speaker or the like. The storage unit 408 is formed from a hard disk, non-volatile memory or the like. The communication unit 409 is formed from a network interface or the like. The drive 410 drives removable media 411 such as a magnetic disk, an optical disc, a magneto optical disc or semiconductor memory.

In the computer 400 that is configured in the abovementioned manner, the abovementioned series of processes is performed by for example, the CPU 401 loading and executing a program, which is stored in the storage unit 408, in the RAM 403 via the input/output interface 405 and the bus 404.

A program that the computer 400 (the CPU 401) executes can for example, be provided stored on removable media 411 as package media or the like. In addition, the program can be provided through a wired or wireless transmission medium such as a local area network, the Internet or a digital satellite broadcast.

In the computer 400, the program can be installed on the storage unit 408 through the input/output interface 405 by mounting the removable media 411 to the drive 410. In addition, the program can be received by the communication unit 409 through a wired or wireless transmission medium and installed on the storage unit 408. In addition to this, the program can be installed on the ROM 402 or the storage unit 408 in advance.

Additionally, the program that the computer 400 executes may be a program in which the processes are performed in time sequence in the order that is described in the present specification, or may be a program in which the processes are performed in parallel or at a desired timing such as when an alert is performed.

The effects that are disclosed in the present specification are merely examples, are not limited and other effects may be possible.

In addition, the embodiment of the present disclosure is not limited tot he abovementioned embodiments, and various alterations are possible within a range than does not depart from the scope of the present disclosure.

For example, the present disclosure may have a configuration in which a shape other than a wedge shape is determined as long as the shape is a shape in which there is a tendency for zipper noise to be generated, and may change the interpolation method on the basis of the determination result.

In addition, the colors that are allocated to each pixel in the low signals may be colors other than red, green and blue.

Furthermore, the present disclosure can have a cloud computing configuration that processes a single function in cooperation by assigning tasks to a plurality of apparatuses through a network.

Further, in addition to being executed by a single apparatus, each step that is described in the abovementioned flowcharts can be executed by being assigned to a plurality of apparatuses.

Furthermore, in a case in which a plurality of processes are included in a single step, in addition to being executed by a single apparatus, the plurality of processes that are included in the single step can be executed by being assigned to a plurality of apparatuses.

Additionally, it is possible for the present disclosure to have configuration such as those below.

(1) An image processing apparatus including a green interpolation unit that, when a shape of low signals, which have, as a signal of each pixel of an image, a color signal that has been allocated to that pixel, is a predetermined shape, creates green image signals for all pixels that correspond to the low signals using only the low signals of green pixels, which are pixels to which green has been allocated.

(2) The image processing apparatus according to (1), in which the green interpolation unit is configured so as to create the green image signals using a class classification adaptive process.

(3) The image processing apparatus according to (2), in which the green interpolation unit derives the green image signals of a target pixel, which is a pixel in the image that is being targeted, through calculation of a predicted coefficient that is learned by solving an equation that represents a relationship, between a teacher signal, which corresponds to the green image signal, of each pixel, a student signal, which corresponds to the low signals of the pixels, and the predicted coefficient, and a predicted tap that is formed from only the low signals of the green pixels than correspond to the target pixel, using the teacher signal and the student signal.

(4) The image processing apparatus according to (2), in which, when the shape of the low signals is not the predetermined shape, the green interpolation unit derives the green image signals of a target pixel, which is a pixel in the image that is being targeted, through calculation of a predicted coefficient that is learned by solving an equation that represents a relationship between a teacher signal, which corresponds to the green image signal, of each pixel, a student signal, which corresponds to the low signals of the pixels, and the predicted coefficient, and a predicted tap that is formed from the low signals that correspond to the target pixel, using the teacher signal and the student signal.

(5) The image processing apparatus according to any one of (1) to (4), further including a shape determination unit that determines that the shape of the low signals is the predetermined shape, in which, when it has been determined by the shape determination unit that the shape of the low signals is the predetermined shape, the green interpolation unit is configured to create the green image signals using only the low signals of the green pixels.

(6) The image processing apparatus according to (5), in which the shape determination unit is configured to determine that the shape of the low signals is the predetermined shape using a threshold value that depends on a color that the low signals display.

(7) The image processing apparatus according to (5) or (6), in which the shape determination unit is configured to perform determination on the basis of the low signals of the green pixels.

(8) The image processing apparatus according to any one of (1) to (7), in which the predetermined shape is configured to be a wedge shape.

(8) An image processing method including, when a shape of low signals, which have, as a signal of each pixel of an image, a color signal that has been allocated to that pixel, is a predetermined shape, creating green image signals for all pixels that correspond to the low signals using only the low signals of green pixels, which are pixels to which green has been at allocated.

(10) A program that causes a computer to function as a green interpolation unit that, when a shape of low signals, which have, as a signal of each pixel of an image, a color signal that has been allocated to that pixel, is a predetermined shape, creates green image signals for all pixels that correspond to the low signals using only the low signals of green pixels, which are pixels to which green has been allocated.

It should be understood by those skilled in the art that various modifications, combinations, sub-combinations and alterations may occur depending on design requirements and other factors insofar as they are within the scope of the appended claims or the equivalents thereof.

1. An image processing apparatus comprising:
a green interpolation unit that, when a shape of low signals, which have, as a signal of each pixel of an image, a color signal that has been allocated to that pixel, is a predetermined shape, creates green image signals for all pixels that correspond to the low signals using only the low signals of green pixels, which are pixels to which green has been allocated.

2. The image processing apparatus according to claim 1,
wherein the green interpolation unit is configured so as to create the green image signals using a class classification adaptive process.

3. The image processing apparatus according to claim 2,
wherein the green interpolation unit derives the green image signals of a target pixel, which is a pixel in the image that is being targeted, through calculation of a predicted coefficient that is learned by solving an equation that represents a relationship between a teacher signal, which corresponds to the green image signal, of each pixel, a student signal, which corresponds to the low signals of the pixels, and the predicted coefficient, and a predicted tap that is formed from only the low signals of the green pixels that correspond to the target pixel, using the teacher signal and the student signal.

4. The image processing apparatus according to claim 2,
wherein when the shapes of the low signals is not the predetermined shape, the green interpolation unit derives the green image signals of a target pixel, which is a pixel in the image that is being targeted, through calculation of a predicted coefficient that is learned by solving an equation that represents a relationship between a teacher signal, which corresponds to the green image signal, of each pixel, a student signal, which corresponds to the low signals of the pixels, and the predicted coefficient, and a predicted tap that is formed from the low signals that correspond to the target pixel, using the teacher signal and the student signal.

5. The image processing apparatus according to claim 1, further comprising:
a shape determination unit that determines that the shape of the low signals, is the predetermined shape,
wherein, when it has been determined by the shape determination unit that the shape of the love signals is the predetermined shape, the green interpolation unit is configured to create the green image signals using only the low signals of the green pixels.

6. The image processing apparatus according to claim 5,
wherein the shape determination unit is configured to determine that the shape of the low signals is the predetermined shape using a threshold value that depends on a color that the low signals display.

7. The image processing apparatus according to claim 5,
wherein the shape determination unit is configured to perform determination on the basis of the low signals of the green pixels.

8. The image processing apparatus according to claim 1,
wherein the predetermined shape is configured to be a wedge shape.

9. An image processing method comprising:
when a shape of low signals, which have, as a signal of each pixel of an image, a color signal that has been allocated to that pixel, is a predetermined shape, creating green image signals for all pixels that correspond to the low signals using only the low signals of green pixels, which are pixels to which green has been allocated.

10. A program that causes a computer to function as a green interpolation unit that, when a shape of low signals, which have, as a signal of each pixel of an image, a color signal that has been allocated to that pixel, is a predetermined shape, creates green image signals for all pixels that correspond to the low signals using only the low signals of green pixels, which are pixels to which green has been allocated.
